(19) United States
(12) Patent Application Publication
(10) Pub. No.: US 2016/0231469 A1
(43) Pub. Date: Aug. 11, 2016

(54) LIGHT DISPERSION MEMBER, DISPLAY DEVICE, AND METHOD FOR PRODUCING LIGHT DISPERSION MEMBER

(71) Applicant: SHARP KABUSHIKI KAISHA, Osaka-shi, Osaka (JP)

(72) Inventors: Yasushi ASAOKA, Osaka-shi, Osaka (JP); Shohei KATSUTA, Osaka-shi, Osaka (JP); Hideomi YUI, Osaka-shi, Osaka (JP); Toru KANNO, Osaka-shi, Osaka (JP); Sho OCHI, Osaka-shi, Osaka (JP); Tsuyoshi MAEDA, Osaka-shi, Osaka (JP)

(21) Appl. No.: 15/023,505

(22) PCT Filed: Sep. 8, 2014
(86) PCT No.: PCT/JP2014/073717

§ 371 Date: Mar. 21, 2016

(30) Foreign Application Priority Data
Sep. 24, 2013 (JP) 2013-197365

(51) Int. Cl. G02B 5/02

(52) U.S. Cl. CPC G02B 5/02; G02B 5/0268

(57) ABSTRACT

A light dispersion member includes a substrate having optical transparency, a light diffusion portion formed with a predetermined height on one surface of the substrate, light shielding layers formed with a thickness smaller than the height of the light diffusion portion in regions other than the light diffusion portion within the one surface of the substrate, and a buffer layer formed on the surface on the opposite side of the light diffusion portion to the surface thereof facing the substrate, the light diffusion portion has a light emitting end surface contacting the substrate and a light incident end surface opposing the light emitting end surface and having a larger area than the area of the light emitting end surface a, and the buffer layer, by elastically deforming when pressure is applied from the substrate side, relaxes pressure applied to the light diffusion portion.

### TECHNICAL FIELD

The present invention relates to a light dispersion member, a display device, and a method for producing the light dispersion member.

This application claims priority based on Japanese Patent Application No. 2013-197365 filed in Japan on Sep. 24, 2013, the entire disclosure of which is incorporated herein by reference.

### BACKGROUND ART

Liquid crystal display devices have been widely used as displays (display devices) for, for example, portable electronic devices, such as a mobile phone, televisions, personal computers, or the like. In general, liquid crystal display devices have characteristics to provide excellent viewability from the front side on the one hand but to provide a narrow viewing angle on the other. Therefore, for liquid crystal display devices, various measures to extend the viewing angle have been conventionally employed. As one such measure, a measure to dispose a light dispersion member on the viewing side of a liquid crystal panel (display unit) and, using the light dispersion member, to disperse light emitted from the viewing side of the liquid crystal panel has been applied.

For example, in PTL 1 below, a light dispersion member that includes a transparent substrate, light diffusion portions having tapered side surfaces formed on one surface of the transparent substrate, and light shielding portions formed in regions other than the regions where the light dispersion members are formed within the one surface of the transparent substrate is disclosed. The light diffusion portions are formed by patterning a transparent negative resist through radiating ultraviolet light (UV light) from the transparent substrate side and making the light shielding portions function as a mask.

### CITATION LIST

### Patent Literature

PTL 1: International Publication No. 2012/081410

### SUMMARY OF INVENTION

### Technical Problem

For a liquid crystal display device, there is a possibility that a large force being applied from the outside to a light dispersion member disposed on the viewing side of the liquid crystal panel causes optical properties of the light dispersion member to deteriorate. That is, in the case in which a large enough force to make a light diffusion portion plastically deform is applied to the light dispersive member, a change in the shape of the light diffusion portion causes a reduction in the light dispersion performance of the light dispersion member.

An aspect of the present invention is proposed in consideration of such a conventional situation, and has an object to provide a light dispersion member that, even in the case in which a force is applied from the outside, is capable of, while preventing a light diffusion portion from plastically deforming, maintaining a light dispersion function of the light diffusion portion, a display device that includes such a light dispersion member, and a method for producing such a light dispersion member.

### Solution to Problem

To achieve the above-described object, the present invention employs the following means.

(1) A light dispersion member according to a first aspect of the present invention includes a substrate that has optical transparency, a light diffusion portion that is formed with a predetermined height on one surface of the substrate, a light shielding layer that is formed with a thickness smaller than the height of the light diffusion portion in a region other than the light diffusion portion within the one surface of the substrate, and a buffer layer that is formed on a surface on the opposite side of the light diffusion portion to a surface thereof facing the substrate. The light diffusion portion has a light emitting end surface that is in contact with the substrate and a light incident end surface that opposes the light emitting end surface and has a larger area than an area of the light emitting end surface. The buffer layer, by elastically deforming when pressure is applied thereto from the substrate side, relaxes pressure applied to the light diffusion portion.

(2) A light dispersion member according to a second aspect of the present invention includes a substrate that has optical transparency, a light diffusion portion that is formed with a predetermined height on the surface of the substrate facing the display unit, and a buffer layer that is formed on a surface on the opposite side of the light diffusion portion to a surface thereof facing the substrate. The light diffusion portion has a light emitting end surface that is in contact with the substrate and a light incident end surface that opposes the light emitting end surface and has a larger area than an area of the light emitting end surface. The buffer layer, by elastically deforming when pressure is applied thereto from the substrate side, relaxes pressure applied to the light diffusion portion.

(3) In the light dispersion member according to the item (1) or (2), the buffer layer may have a lower compressive elastic modulus than the light diffusion portion.

(4) In the light dispersion member according to any one of the items (1) to (3), a thickness of the buffer layer may be smaller than a height of a space formed between the light diffusion portion and the light shielding layer.

(5) In the light dispersion member according to any one of the items (1) to (4), the buffer layer may have adhesion and be adhered to the light incident end surface of the light diffusion portion.

(6) In the light dispersion member according to any one of the items (1) to (5), the light dispersion member may have a substrate that has optical transparency on a surface on the opposite side of the buffer layer to a surface thereof facing the light diffusion portion, and the substrate may have a higher compressive elastic modulus than the buffer layer.

(7) In the light dispersion member according to any one of the items (1) to (6), the buffer layer has a lower refractive index than the light diffusion portion.

(8) In the light dispersion member according to any one of the items (1) to (7), the buffer layer may have optical transparency to ultraviolet light.

(9) In the light dispersion member according to any one of the items (1) to (8), the light dispersion member may have a direction in which scattering intensity of light becomes relatively great and a direction in which scattering intensity of light becomes relatively small because of azimuthal anisotropy of the light diffusion portion.

(10) In the light dispersion member according to the item (9), the direction in which the scattering intensity of light becomes relatively great may be parallel to a direction positioned between two diagonals when a shape of the light dispersion member is a rectangle.

(11) A display device according to a third aspect of the present invention includes a display unit, a light dispersion member that is disposed on a viewing side of the display unit, and a buffer layer that is interposed between the display unit and the light dispersion member. The buffer layer, by elastically deforming when pressure is applied thereto from the light dispersion member side, relaxes pressure applied to the light dispersion member.

(12) In the display device according to the item (11), the light dispersion member may have a substrate that has optical transparency, a light diffusion portion that is formed with a predetermined height on one surface of the substrate, and a light shielding layer that is formed with a thickness smaller than the height of the light diffusion portion in a region other than the light diffusion portion within the one surface of the substrate, the light diffusion portion may include a light emitting end surface that is in contact with the substrate and a light incident end surface that opposes the light emitting end surface and has a larger area than an area of the light emitting end surface, and the buffer layer may be disposed between the display unit and the light diffusion portion.

(13) A method for producing a light dispersion member according to a fourth aspect of the present invention is a method for producing a light dispersion member that includes a substrate that has optical transparency, a light diffusion portion that is formed with a predetermined height on one surface of the substrate, a light shielding layer that is formed with a thickness smaller than the height of the light diffusion portion in a region other than the light diffusion portion within the one surface of the substrate, and a buffer layer that is formed on a surface on the opposite side of the light diffusion portion to a surface thereof facing the substrate, and includes a step of forming the light shielding layer on a long substrate sheet that is formed into the substrate, a step of forming the light diffusion portion on the substrate sheet on which the light shielding layer is formed, a step of laminating a long buffer layer sheet that is formed into the buffer layer on the substrate sheet on which the light diffusion portion is formed, and a step of winding the substrate sheet on which the buffer layer sheet is laminated.

(14) A method for producing a light dispersion member according to a fifth aspect of the present invention is a method for producing a light dispersion member that includes a substrate that has optical transparency, a light diffusion portion that is formed with a predetermined height on the surface of the substrate facing the display unit, and a buffer layer that is formed on a surface on the opposite side of the light diffusion portion to a surface thereof facing the substrate, and includes a step of forming the light diffusion portion on a long substrate sheet that is formed into the substrate, a step of laminating a long buffer layer sheet that is formed into the buffer layer on the substrate sheet on which the light diffusion portion is formed, and a step of winding the substrate sheet on which the buffer layer sheet is laminated.

### Advantageous Effects of Invention

As described above, according to an aspect of the present invention, it is possible to provide a light dispersion member that, even in the case in which a force is applied from the outside, is capable of, while preventing a light diffusion portion from plastically deforming, maintaining a light dispersion function of the light diffusion portion, a display device that includes such a light dispersion member, and a method for producing such a light dispersion member.

### BRIEF DESCRIPTION OF DRAWINGS

FIG. 1 is a cross-sectional view of a liquid crystal display device according to a first embodiment of the present invention.

FIG. 2 is a cross-sectional view of a liquid crystal panel included in the liquid crystal display device according to the first embodiment of the present invention.

FIG. 3 includes schematic views for a description of an operation of the liquid crystal panel included in the liquid crystal display device according to the first embodiment of the present invention.

FIG. 4 is a perspective view of a buffer layer-containing light dispersion member included in the liquid crystal display device according to the first embodiment of the present invention.

FIG. 5 is a configuration diagram of the buffer layer-containing light dispersion member according to the first embodiment of the present invention.

FIG. 6 is a schematic view for a description of a relation between a polar angle and an azimuth angle on a screen of the liquid crystal panel included in the liquid crystal display device according to the first embodiment of the present invention.

FIG. 7 is a schematic view illustrating, in azimuth angles, horizontal directions and vertical directions on the screen of the liquid crystal panel included in the liquid crystal display device according to the first embodiment of the present invention.

FIG. 8 is a schematic view illustrating a relation between azimuth angle directions in which the diffusibility of the light dispersion member becomes relatively great and transparent axes of polarizers according to the first embodiment of the present invention.

FIG. 9 includes cross-sectional views describing a case in which an external force is applied to the buffer layer-containing light dispersion member according to the first embodiment of the present invention.

FIG. 10 is a side view illustrating an example of a production apparatus of the buffer layer-containing light dispersion member according to the first embodiment of the present invention.

FIG. 11 is a flowchart illustrating a production process of the buffer layer-containing light dispersion member according to the first embodiment of the present invention.

FIG. 12 includes perspective views of a liquid crystal display device according to a second embodiment of the present invention.

FIG. 13 is a cross-sectional view of a buffer layer-containing light dispersion member included in the liquid crystal display device according to the second embodiment of the present invention.

FIG. 14 is a cross-sectional view of a liquid crystal display device according to a third embodiment of the present invention.

FIG. 15 is a cross-sectional view of a buffer layer-containing light dispersion member included in the liquid crystal display device according to the third embodiment of the present invention.

FIG. 16 includes diagrams exemplifying plain shapes of a light shielding layer.

FIG. 17 is a front view of a liquid crystal television according to a fourth embodiment of the present invention.

FIG. 18 is a cross-sectional view of a buffer layer-containing light dispersion member according to a fifth embodiment of the present invention.

### DESCRIPTION OF EMBODIMENTS

Hereinafter, embodiments of the present invention will be described in detail with reference to the accompanying drawings.

In all drawings below, to make respective components easy to be recognized, different components will sometimes be illustrated with different scales of dimensions.

### First Embodiment

### Liquid Crystal Display Device

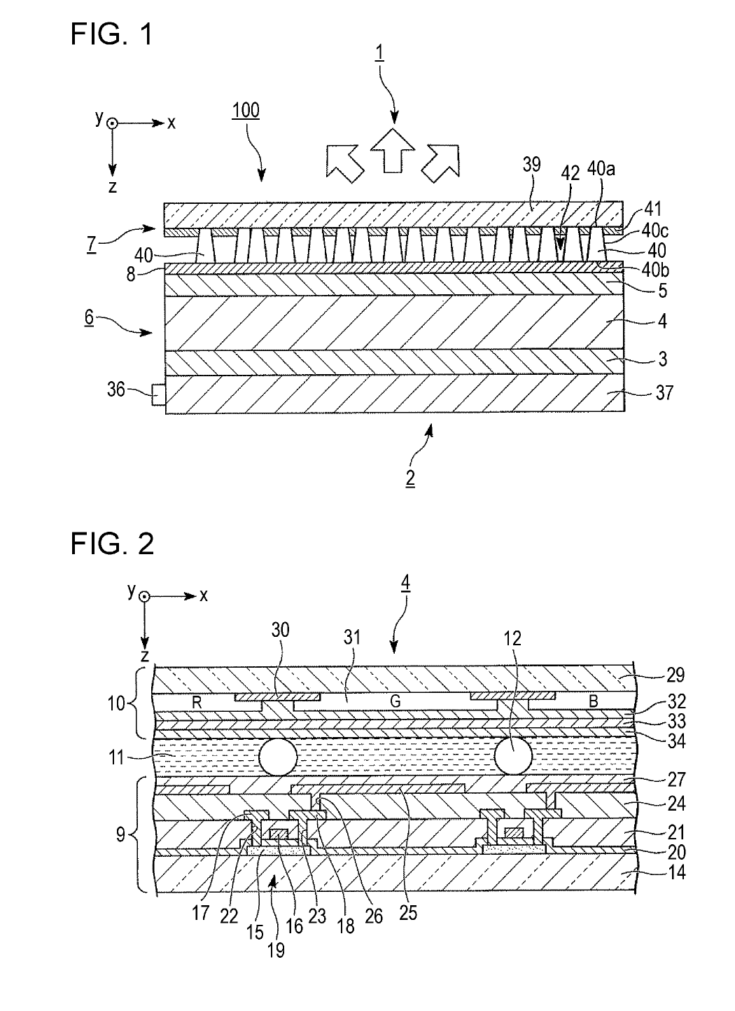

First, as a first embodiment of the present invention, a liquid crystal display device 1 illustrated in FIG. 1 will be described.

FIG. 1 is a cross-sectional view illustrating a schematic configuration of the liquid crystal display device 1.

As illustrated in FIG. 1, the liquid crystal display device 1 includes a backlight 2, a first polarizer 3, a liquid crystal panel 4, a second polarizer 5, a light dispersion member 7, and a buffer layer 8. Among the components, the backlight 2, the first polarizer 3, the liquid crystal panel 4, and the second polarizer 5 constitute a liquid crystal display unit 6. On the other hand, the light dispersion member 7 and the buffer layer 8 constitute a buffer layer-containing light dispersion member 100.

In the following description, a side on which the light dispersion member 7 is disposed is referred to as a viewing side and a side on which the backlight 2 is disposed is referred to as a rear side. It is assumed that the x axis, the y axis, and the z axis, illustrated in FIG. 1, represent the horizontal direction in a screen of the liquid crystal panel 4, the vertical direction in the screen of the liquid crystal panel 4, and the thickness direction of the liquid crystal panel 4, respectively.

The backlight 2 includes a light source 36, which is made of for example, a light-emitting diode, a cold-cathode tube, or the like, and a light guide 37 that causes light emitted from the light source 36 to be emitted toward the liquid crystal panel 4 using internal reflection of the light. The light source 36 is disposed on an end face of the light guide 37 (referred to as an edge-light type). Alternatively, the light source 36 may be configured to be disposed directly under the light guide 37 (referred to as a direct type). The light guide 37 has a function to guide light emitted from the light source 36 to the liquid crystal panel 4. As a material of the light guide 37, a resin material, such as acrylic resin, is used.

Light that is incident on the end face of the light guide 37 from the light source 36 is propagated inside the light guide 37 while being subject to total reflection and emitted from the upper surface (light emitting surface) of the light guide 37 with a substantially uniform intensity. Although not illustrated, on the upper surface of the light guide 37, a scattering sheet and a prism sheet are disposed. The light emitted from the upper surface of the light guide 37 is, after being scattered by the scattering sheet, concentrated and substantially parallelized by the prism sheet to be emitted. For the prism sheet, for example, BEF (trade name) produced by Sumitomo 3M Limited is used.

In the embodiment, a backlight (low directivity backlight) that is configured to have a gentle directivity to some extent by controlling light-emitting directions is suitably used as the backlight 2. Regarding the backlight 2, use of a backlight configured to have directivity (directivity backlight) is not necessarily precluded.

The first polarizer 3 is a component that functions as a polarizer and is disposed between the backlight 2 and the liquid crystal panel 4. On the other hand, the second polarizer 5 is a component that functions as an analyzer, and is disposed between the liquid crystal panel 4 and the light dispersion member 7. The first polarizer 3 and the second polarizer 5 are disposed in such a way that the polarization axes (transparent axes) of the respective polarizer are orthogonal to each other (referred to as a cross-Nicole position).

The liquid crystal panel 4 is, for example, a transparent type liquid crystal panel. For the liquid crystal panel 4, without being limited to a transparent type liquid crystal panel, a semi-transparent type (transparent-reflection double type) liquid crystal panel and a reflection type liquid crystal panel may be used. The liquid crystal panel 4 is an active matrix type liquid crystal panel, which is provided with thin film transistors (TFTs) as switching elements to switch operations of respective pixels. The liquid crystal panel 4 may, without being limited to an active matrix type liquid crystal panel, be a simple matrix type liquid crystal panel, which is not provided with switching elements.

The light dispersion member 7 is a component that extends a viewing angle by dispersing light emitted from the viewing side of the liquid crystal panel 4 (viewing angle extending film), and is disposed on the viewing side (second polarizer 5) of the liquid crystal panel 4.

The buffer layer 8 is a component that, by elastically deforming when pressure is applied from the light dispersion member 7 side, relaxes pressure applied to the light dispersion member 7 and is disposed between the liquid crystal panel 4 (liquid crystal display unit 6) and the light dispersion member 7 in an interposing manner.

Although the embodiment has a configuration in which the buffer layer-containing light dispersion member 100 is disposed on the viewing side of the liquid crystal panel 4, the buffer layer 8 is not limited to a buffer layer formed in one body with the light dispersion member 7 and may be a buffer layer formed as a separate body from the light dispersion member 7 and be disposed between the liquid crystal panel 4 and the light dispersion member 7.

The liquid crystal display device 1 having the configuration described above modulates light emitted from the backlight 2 by the liquid crystal panel 4 and displays predetermined images, characters, and so on by the modulated light. When the light emitted from the liquid crystal panel 4 is transmitted through the light dispersion member 7 to be emitted, the emitted light comes to be in a state of having more widely spread angular distribution than the light before being incident to the light dispersion member 7. With this feature, an observer is able to view the display with a wide viewing angle.

In the liquid crystal display device 1, even in the case in which a force is applied to the light dispersion member 7, which is disposed on the viewing side of the liquid crystal panel 4, from the outside, the buffer layer 8, by elastically deforming due to pressure applied from the light dispersion member 7 side, relaxes pressure applied to the light dispersion member 7. With this feature, it is possible to prevent the light dispersion performance (optical properties) of the light dispersion member 7 from deteriorating while preventing the light dispersion member 7 from deforming.

### Liquid Crystal Panel

Next, a specific configuration of the liquid crystal panel 4 will be described with reference to FIG. 2.

FIG. 2 is a cross-sectional view illustrating a schematic configuration of the liquid crystal panel 4.

As illustrated in FIG. 2, the liquid crystal panel 4 substantially includes a TFT substrate (also referred to as an element substrate) 9, a color filter substrate (also referred to as a counter substrate) 10 that is disposed in such a way as to oppose the TFT substrate 9, and a liquid crystal layer 11 that is disposed between the TFT substrate 9 and the color filter substrate 10.

Sealing the periphery of a space between the TFT substrate 9 and the color filter substrate 10 with sealing member (not illustrated) and injecting liquid crystal into the space cause the liquid crystal layer 11 to be held between the TFT substrate 9 and the color filter substrate 10. Spherical spacers 12 are disposed between the TFT substrate 9 and the color filter substrate 10 so that the distance therebetween is maintained uniform.

The liquid crystal panel 4 of the embodiment performs display in, for example, a twisted nematic (TN) mode, and a TN liquid crystal is used for the liquid crystal layer 11. As a display mode, not only the TN mode but also, for example, a vertical alignment (VA) mode, an super twisted nematic (STN) mode, an in-plane switching (IPS) mode, or the like may be used.

In the TFT substrate 9, a plurality of pixels (not illustrated) each of which is a smallest unit area of display are disposed side by side in a matrix. In the TFT substrate 9, a plurality of source bus lines (not illustrated) are formed in such a way as to extend in parallel to one another, and a plurality of gate bus lines (not illustrated) are formed in such a way as to extend in parallel to one another and intersect the plurality of source bus lines at right angles. Thus, in the TFT substrate 9, the plurality of source bus lines and the plurality of gate bus lines are formed in a grid, and a rectangular area enclosed by adjacent source bus lines and adjacent gate bus lines becomes a single pixel. The source bus lines and the gate bus lines are connected to source electrodes and gate electrodes of TFTs, which will be described later, respectively.

On the surface on the liquid crystal layer 11 side of the transparent substrate 14, which constitutes the TFT substrate 9, TFTs 19 each of which has a semiconductor layer 15, a gate electrode 16, a source electrode 17, a drain electrode 18, and so on are formed. For the transparent substrate 14, for example, a glass substrate may be used. On the transparent substrate 14, the semiconductor layers 15, which are made of a semiconductor material, such as continuous grain silicon (CGS), low-temperature poly-silicon (LPS), and amorphous silicon (α-Si), are formed. On the transparent substrate 14, a gate insulating film 20 is also formed in such a way as to cover the semiconductor layers 15. As a material of the gate insulating film 20, for example, a silicon oxide film, a silicon nitride film, or a stacked film thereof is used. On the gate insulating film 20, the gate electrodes 16 are formed in such a way as to oppose the semiconductor layers 15. As a material of the gate electrodes 16, for example, stacked film of tungsten (W) and tantalum nitride (TaN), molybdenum (Mo), titanium (Ti), aluminum (Al), or the like is used.

On the gate insulating film 20, a first interlayer insulating film 21 is formed in such a way as to cover the gate electrodes 16. As a material of the first interlayer insulating film 21, for example, a silicon oxide film, a silicon nitride film, a stacked film thereof, or the like is used. On the first interlayer insulating film 21, the source electrodes 17 and the drain electrodes 18 are formed. The source electrodes 17 are connected to source regions of the semiconductor layers 15 via contact holes 22 that penetrate the first interlayer insulating film 21 and the gate insulating film 20. In a similar manner, the drain electrodes 18 are connected to drain regions of the semiconductor layers 15 via contact holes 23 that penetrate the first interlayer insulating film 21 and the gate insulating film 20. As materials of the source electrodes 17 and the drain electrodes 18, the same conductive material as the one used for the above-described gate electrodes 16 is used. On the first interlayer insulating film 21, a second interlayer insulating film 24 is formed in such a way as to cover the source electrodes 17 and the drain electrodes 18. As a material of the second interlayer insulating film 24, the same material as the one used for the above-described first interlayer insulating film 21 or an organic insulating material is used.

On the second interlayer insulating film 24, pixel electrodes 25 are formed. The pixel electrodes 25 are connected to the drain electrodes 18 via contact holes 26 that penetrate the second interlayer insulating film 24. That is, the pixel electrodes 25 use the drain electrodes 18 as relay electrodes to be connected to the drain regions of the semiconductor layers 15. As a material of the pixel electrodes 25, for example, a transparent conductive material, such as indium tin oxide (ITO) and indium zinc oxide (IZO), is used. With this configuration, when a scanning signal is provided through a gate bus line and a TFT 19 is turned on, an image signal that is provided to the source electrode 17 thereof through a source bus line is provided to the pixel electrode 25 thereof via the semiconductor layer 15 and drain electrode 18 thereof. On the second interlayer insulating film 24, an alignment film 27 is formed across the entire surface thereof in such a way as to cover the pixel electrodes 25. The alignment film 27 has alignment restricting force that vertically aligns liquid crystal molecules constituting the liquid crystal layer 11. Regarding the form of the TFTs, not only top-gate type TFTs illustrated in FIG. 2 but also bottom-gate type TFTs may be used.

On the other hand, on the surface on the liquid crystal layer 11 side of a transparent substrate 29 that constitutes the color filter substrate 10, a black matrix 30, color filters 31, a planarization layer 32, a counter electrode 33, and an alignment film 34 are formed successively. The black matrix 30 has a function to block the transmission of light in inter-pixel regions, and is formed from a metal, such as chromium (Cr) and multilayer film of Cr and Cr oxide, or a photoresist made by dispersing carbon particles in photo-sensitive resin. In the color filters 31, pigments having respective colors of red (R), green (G), and blue (B) are contained, and, with respect to each pixel electrode 25 on the TFT substrate 9, a color filter 31 having any one color of R, G, and B is disposed in an opposing manner. The color filters 31 may have a multi-color composition of three colors, that is, R, G, and B, or more. The planarization layer 32 is made of an insulating film that covers the black matrix 30 and the color filters 31, and has a function to relax level differences created by the black matrix 30 and the color filters 31 to achieve planarization. On the planarization layer 32, the counter electrode 33 is formed. As a material of the counter electrode 33, a transparent conductive material, which is the same as the material of the pixel electrodes 25, is used. Across the entire surface on the counter electrode 33, the alignment film 34 that has vertical alignment restricting force is formed.

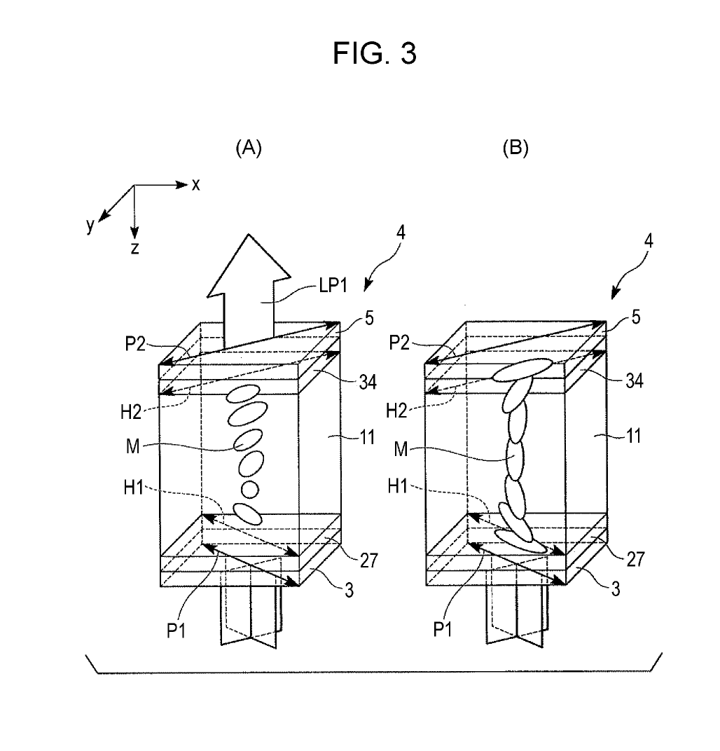

FIGS. 3(A) and (B) are schematic views for a description of an operation of the liquid crystal panel 4.

FIG. 3(A) is a diagram illustrating a state in which no voltage is applied to the liquid crystal panel 4 (between a pixel electrode 25 and the counter electrode 33 illustrated in FIG. 2) (no-voltage-applied state). FIG. 3(B) is a diagram illustrating a state in which a certain voltage is applied to the liquid crystal panel 4 (voltage-applied state). In FIGS. 3(A) and (B), a reference character M represents liquid crystal molecules constituting the liquid crystal layer 11. A transparent axis P1 of the first polarizer 3 and a transparent axis of the second polarizer 5 are arranged in a cross-Nicole relationship.

When in the no-voltage-applied state, the liquid crystal molecules M are in a state of being twisted 90° between the alignment film 27 and the alignment film 34, as illustrated in FIG. 3(A). At this time, the polarization plane of linearly polarized light that has been transmitted through the first polarizer 3 having the transparent axis P1 along the 135°-315° directions rotates 90° due to optical rotation that the liquid crystal layer 11 has. Due to the rotation, the linearly polarized light that has been transmitted through the first polarizer 3 is transmitted through the second polarizer 5 that has a transparent axis P2 along the 45°-225° directions. As a result, white is displayed when in the no-voltage-applied state.

When in the voltage-applied state, the liquid crystal molecules M are in a state of being erected in the direction along electric field between the alignment film 27 and the alignment film 34, as illustrated in FIG. 3(B). At this time, the polarization plane of the linearly polarized light that has been transmitted through the first polarizer 3 having the transparent axis P1 along the 135°-315° directions does not rotate. Therefore, the linearly polarized light that has been transmitted through the first polarizer 3 is not transmitted through the second polarizer 5 that has the transparent axis P2 along the 45°-225° directions. As a result, black is displayed when in the voltage-applied state.

As described above, the liquid crystal panel 4 is capable of switching between white display and black display by controlling whether or not to apply a voltage with respect to each pixel and thereby displaying an image.

Regarding a production process of the liquid crystal display unit 6, first, the TFT substrate 9 and the color filter substrate 10 are individually fabricated. Thereafter, the TFT substrate 9 and the color filter substrate 10 are disposed in such a way that the surface on the side of the TFT substrate 9 on which the TFTs 19 are formed faces the surface on the side of the color filter substrate 10 on which the color filters 31 are formed, and the TFT substrate 9 and the color filter substrate 10 are pasted together with a sealing member interposed therebetween. Thereafter, liquid crystal is injected into a space enclosed by the TFT substrate 9, the color filter substrate 10, and the sealing member. Then, on both sides of the liquid crystal panel 4 produced through the above-described process, the first polarizer 3 and the second polarizer 5 are individually adhered using optical adhesive or the like. By going through the steps as described above, the liquid crystal display unit 6 is produced.

Since conventionally known methods are applicable to the method for producing the TFT substrate 9 and the color filter substrate 10, a description thereof will be omitted.

### Buffer Layer-Containing Light Dispersion Member

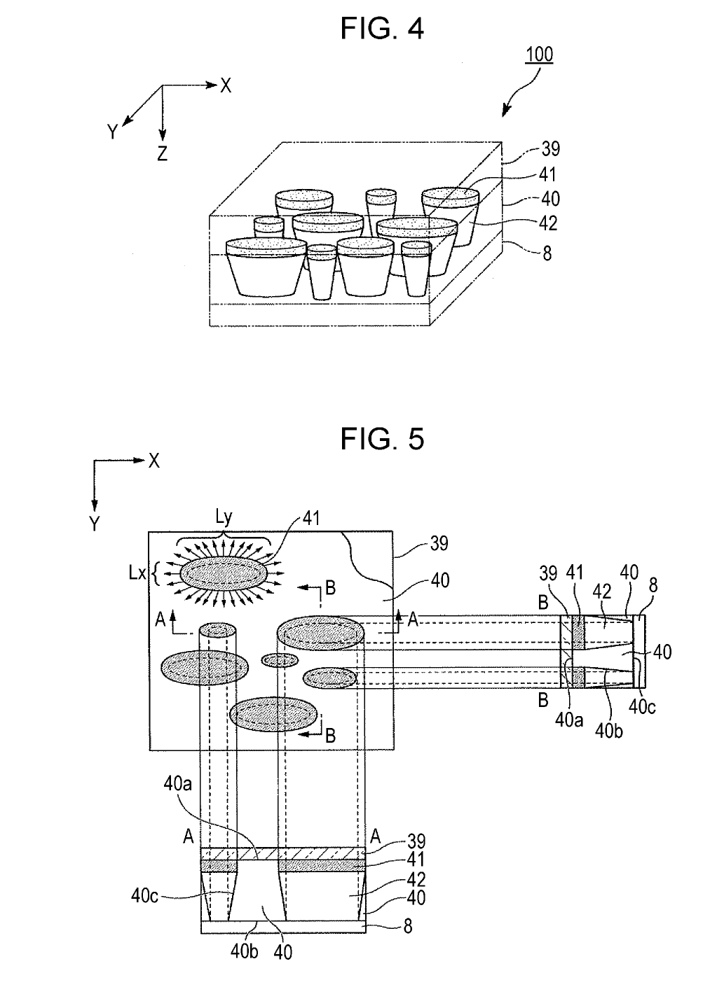

Next, a specific configuration of the buffer layer-containing light dispersion member 100 will be described with reference to FIGS. 4 and 5.

FIG. 4 is a perspective view of the buffer layer-containing light dispersion member 100 when viewed from the viewing side. FIG. 5 is a schematic view illustrating a configuration of the light dispersion member 7. The upper left drawing in FIG. 5 illustrates a plan view of the light dispersion member 7. The lower left drawing in FIG. 5 illustrates a cross-sectional view taken along the line A-A in the upper left plan view. The upper right drawing in FIG. 5 illustrates a cross-sectional view taken along the line B-B in the upper left plan view.

As illustrated in FIGS. 4 and 5, the buffer layer-containing light dispersion member 100 is composed of the light dispersion member 7 and the buffer layer 8 that are formed in one body.

The light dispersion member 7 includes a substrate 39 that has optical transparency, a light diffusion portion 40 that is formed on one surface (the surface on the opposite side to the viewing side) of the substrate 39, and light shielding layers (light absorbing portions) 41, and has a structure in which, in a region where the light diffusion portion 40 is formed, the light shielding layers 41 are arranged separately into a plurality of regions.

For the substrate 39, it is preferable to use transparent resin film, such as triacetyl cellulose (TAC) film, polyethylene terephthalate (PET), polycarbonate (PC), polyethylene naphthalate (PEN), and polyether sulphone (PES) film. The substrate 39 is to be used as a base layer in the case of forming the light shielding layers 41 and the light diffusion portion 40 in latter steps in the after-mentioned production process, and is thus required to have heat resistance and mechanical strength in a heat treatment step in the production process. Therefore, for the substrate 39, not only a resin substrate but also a glass substrate or the like may be used. However, it is preferable that the thickness of the substrate 39 is set thin to an extent not impairing heat resistance and mechanical strength. That is because, the thicker the thickness of the substrate 39 becomes, the higher possibility of producing a blur to a display is caused. In the embodiment, as an example of the substrate 39, a transparent resin film of a thickness of 100 μm is used. It is also preferable that the total light transmittance of the substrate 39 is 90% or higher in accordance with the provisions of JIS K7361-1. Setting the total light transmittance at 90% or higher enables sufficient transparency to be obtained.

The light diffusion portion 40 is made of an organic material that has optical transparency and photosensitivity, such as acrylic resin and epoxy resin. It is preferable that the total light transmittance of the light diffusion portion 40 is 90% or higher in accordance with the provisions of JIS K7361-1. Setting the total light transmittance at 90% or higher enables sufficient transparency to be obtained.

The light diffusion portion 40 has a light emitting end surface 40a, a light incident end surface 40b, and side surfaces 40c. The light emitting end surface 40a is a surface that is in contact with the substrate 39. The light incident end surface 40b is a surface that opposes the light emitting end surface 40a. The side surfaces 40c are surfaces that are formed between the light emitting end surface 40a and the light incident end surface 40b. The area of the light incident end surface 40b is larger than the area of the light emitting end surface 40a. That is, the light diffusion portion 40 has horizontal cross sections the areas of which gradually increase from the substrate 39 side toward the opposite side to the substrate 39. Thus, each side face 40c of the light diffusion portion 40 is an inclined face that is inclined in a reversely tapered manner from the substrate 39 side toward the opposite side to the substrate 39.

The light diffusion portion 40 is a portion that contributes to the transmission of light in the light dispersion member 7. That is, light that is incident on the light incident end surface 40b of the light diffusion portion 40 is guided in a state of being substantially confined inside the light diffusion portion 40 while being totally reflected by the side surfaces 40c of the light diffusion portion 40 and emitted from the light emitting end surface 40a.

It is preferable that an angle formed by each side face 40 with the light incident end surface 40b (hereinafter, referred to as a taper angle) is 75° or larger and 88° or smaller. In the embodiment, the taper angle of each side face 40c is 85°. However, the taper angle of each side face 40c is not limited to a specific value as long as the taper angle is an angle that enables incident light to be sufficiently dispersed in the case of emitting the light from the light dispersion member 7. In the embodiment, the taper angles of the side surfaces 40c are set to an identical value.

The height of the light diffusion portion 40 from the light incident end surface 40b to the light emitting end surface 40a is set larger than the layer thickness of the light shielding layers 41. In the embodiment, the layer thickness of the light shielding layers 41 is, as an example, approximately 150 nm. The height of the light diffusion portion 40 from the light incident end surface 40b to the light emitting end surface 40a is, as an example, approximately 20 μm.

The light shielding layers 41 are layers that shield (absorb) light leaking out from the side surfaces 40c of the light diffusion portion 40. The light shielding layers 41 are formed in regions other than the region where the light diffusion portion 40 is formed within the surface on the side of the substrate 39 at which the light diffusion portion 40 is formed with a thickness smaller than the height of the light diffusion portion 40.

The light shielding layers 41 are arranged at non-periodical when viewed from the normal direction of the principal face of the substrate 39. The light shielding layers 41 are, as an example, made of black resin containing black inorganic particles, such as carbon, iron oxide, and silver oxide, or an organic material having light absorbency and photosensitivity, such as black resist and black ink. Furthermore, metal film, such as chromium (Cr) and multilayer film of Cr and Cr oxide, may be used.

The light dispersion member 7 has a plurality of air-cavities 42. The air-cavities 42 are spaces enclosed by the side surfaces 40c of the light diffusion portion 40 and the light shielding layers 41, and, inside the air-cavities 42, air is contained. On the other hand, to portions other than the plurality of air-cavities 42, the light diffusion portion 40 is disposed in a continuous manner.

It is desirable that the refractive index of the substrate 39 is substantially the same as the refractive index of the light diffusion portion 40. The reason for the above is as follows. For example, a case in which the refractive index of the substrate 39 greatly differs from the refractive index of the light diffusion portion 40 is assumed. In this case, in the case in which light that is incident on the light incident end surface 40b is emitted from the light emitting end surface 40a, unnecessary refraction and reflection of light are caused sometimes at the boundary face between the light diffusion portion 40 and the substrate 39. In this case, there is a possibility that problems in that a desirable viewing angle is not obtained, the quantity of emitted light decreases, and so on are caused, which is the reason for the desirable refractive index setting.

In the case of the embodiment, the insides of the air-cavities 42 (the outside of the light diffusion portion 40) are filled with air. For this reason, in the case in which it is assumed that the light diffusion portion 40 is formed of for example, transparent acrylic resin, the side surfaces 40c of the light diffusion portion 40 becomes boundary faces between the transparent acrylic resin and the air. The air-cavities 42 may be filled with another low refractive index material. However, a case in which air exists in the outside produces a larger refractive index difference at a boundary face between the inside and outside of the light diffusion portion 40 than cases in which any other low refractive index materials exist in the outside. Therefore, because of Snell's law, the configuration of the embodiment produces a smallest critical angle and a widest range of angle of incidence in which light is totally reflected by the side surfaces 40c of the light diffusion portion 40. As a result, it becomes possible to further suppress loss of light and obtain a high luminance.

The plurality of light shielding layers 41 are disposed in a scattered manner on one surface of the substrate 39. The planar shapes of the light shielding layers 41 when viewed from the normal direction of the substrate 39 are long and narrow ellipses. Portions occupying areas beneath the light shielding layers 41 are the air-cavities 42 shaped in elliptic conical frustums.

Each light shielding layer 41 has a major axis and a minor axis. It is assumed that the major axis is an axis having a longest length in the planar shape of each light shielding layer 41 when viewed from the normal direction of the substrate 39. It is assumed that the minor axis is an axis having a shortest length in the planar shape of each light shielding layer 41 when viewed from the normal direction of the substrate 39. In the light dispersion member 7 of the embodiment, the respective light shielding layers 41 have substantially the same ratio of the minor axis length to the major axis length.

In the light dispersion member 7 of the embodiment, the major axis directions of an ellipse forming the planar shape of each light shielding layer 41 (hereinafter, sometimes referred to as major axis directions of a light shielding layer) are substantially aligned with the X-directions. The minor axis directions of an ellipse forming the planar shape of each light shielding layer 41 (hereinafter, sometimes referred to as minor axis directions of a light shielding layer) are substantially aligned with the Y-directions. Consequently, when taking into consideration the directions of the side surfaces 40c of the light diffusion portion 40, the ratio of side surfaces 40c along the X-directions to all the side surfaces 40c of the light diffusion portion 40 is larger than the ratio of side surfaces 40c along the Y-directions to all the side surfaces 40c of the light diffusion portion 40. Therefore, the quantity of light Ly that is reflected by the side surfaces 40c along the X-directions and dispersed in the Y-directions is greater than the quantity of light Lx that is reflected by the side surfaces 40c along the Y-directions and dispersed in the X-directions.

That is, the light diffusion portion 40 has azimuthal anisotropy in which, with respect to the side surfaces 40c formed between the light emitting end surface 40a and the light incident end surface 40b, scattering intensity of light becomes relatively greater in azimuthal directions along which the area of the side surfaces 40c takes a smaller value than in azimuthal directions along which the area of the side surfaces 40c takes a larger value. In the light dispersion member 7, directions in which scattering intensity of light becomes relatively great due to the azimuthal anisotropy of the light diffusion portion 40 are the Y-directions, which are the minor axis directions of each light shielding layer 41, and directions in which scattering intensity of light becomes relatively small due to the azimuthal anisotropy of the light diffusion portion 40 are the X-directions, which are the major axis directions of each light shielding layer 41.

In the light dispersion member 7, the directions in which scattering intensity of light becomes greatest (referred to as azimuth angle directions) are parallel to directions positioned between the two diagonals when the shape of the light dispersion member 7 is a rectangle. In the liquid crystal display device 1, the azimuth angle directions of the light dispersion member 7 coincide with improvement directions of viewing angle characteristic for the screen of the liquid crystal panel 4. Specifically, the azimuth angle directions (Y-directions) of the light dispersion member 7 coincide with the vertical directions in the screen of the liquid crystal panel 4. The liquid crystal display device 1 is capable of displaying images that are bright and excel in viewability by the light dispersion member 7 with such azimuthal anisotropy efficiently dispersing light in the improvement directions of viewing angle characteristic for the liquid crystal panel 4.

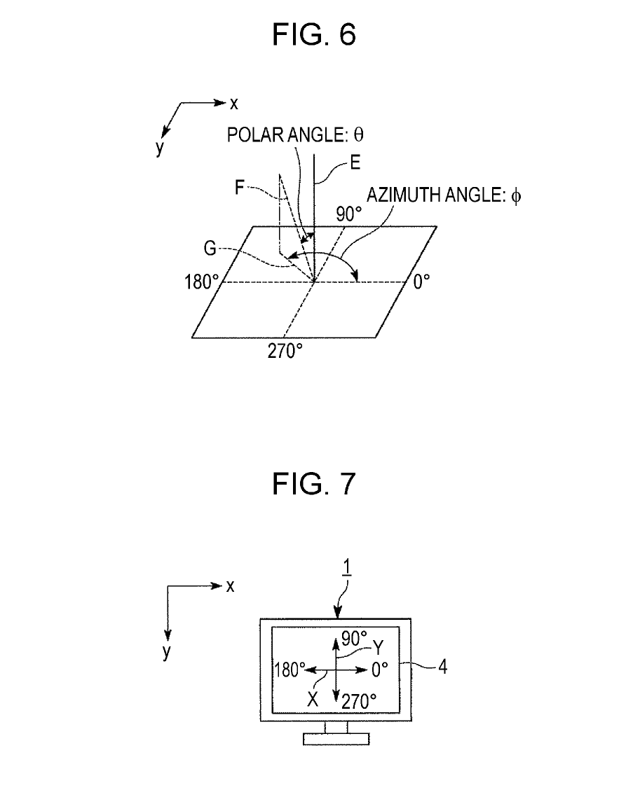

It is assumed that, as illustrated in FIG. 6, an angle formed by a line of sight F of an observer based on the normal direction E of the screen of the liquid crystal panel 4 included in the liquid crystal display device 1 is a polar angle θ. It is also assumed that an angle formed by a direction along a line segment G created by projecting the line of sight F of the observer onto the screen based on the positive direction (0° direction) of the x axis is an azimuth angle φ. FIG. 6 is a schematic view for a description of a relation between a polar angle θ and an azimuth angle φ.

As illustrated in FIG. 7, the frontal shape of the screen of the liquid crystal panel 4 included in the liquid crystal display device 1 is a rectangle that is long in the right and left directions (horizontally long). It is assumed that the horizontal directions in the screen are the directions at azimuth angles φ of 0° and 180°. The directions at azimuth angles φ of 0° and 180° are, plainly speaking, the right and left directions along an axis horizontal to the ground (X-directions). On the other hand, it is also assumed that the vertical directions in the screen are the directions at azimuth angles φ of 90° and 270°. The directions at azimuth angles φ of 90° and 270° are, plainly speaking, the up and down directions along an axis vertical to the ground (Y-directions). FIG. 7 is a schematic view in which the horizontal directions and the vertical directions in the screen of the liquid crystal panel 4 included in the liquid crystal display device 1 are represented in azimuth angles φ.

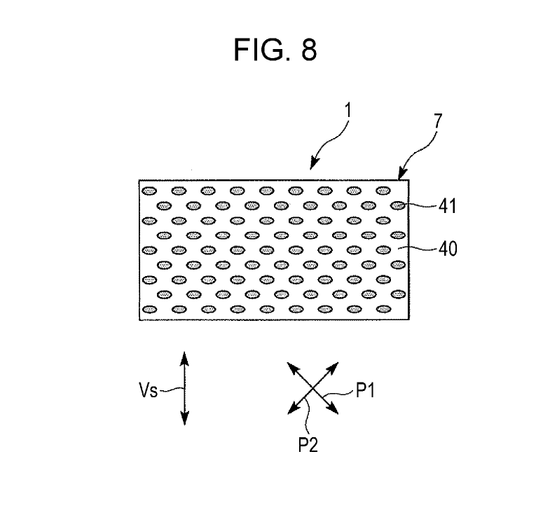

FIG. 8 is a schematic view illustrating a relation among azimuth angle directions Vs in which the diffusibility of the light dispersion member 7 becomes relatively great, the transparent axis P1 of the first polarizer 3, and the transparent axis P2 of the second polarizer 5. For the light dispersion member 7 illustrated in FIG. 8, for the sake of simplicity, a case in which the plurality of light shielding layers 41 are regularly arranged in the same size is illustrated.

As illustrated in FIG. 8, it is assumed that, in the liquid crystal display device 1 of the embodiment, the azimuth angle directions Vs in which the diffusibility of the light dispersion member 7 becomes relatively great are the directions at azimuth angles φ of 90° and 270° (Y-directions) in the screen of the liquid crystal panel 4. Due to this configuration, dispersion intensity in the up and down directions becomes great in the liquid crystal display device 1, and viewability in the up and down directions is further improved.

In the liquid crystal display device 1 of the embodiment, the azimuth angle directions Vs in which the diffusibility of the light dispersion member 7 becomes relatively great, the transparent axis P1 of the first polarizer 5, and the transparent axis P2 of the second polarizer 5 are set so that the azimuth angle directions Vs and each of the transparent axis P1 and the transparent axis P2 form an angle of substantially 45° therebetween.

The azimuth angle directions Vs in which the diffusibility of the light dispersion member 7 becomes relatively great and the short sides of the substrate 39 do not have to coincide with each other exactly (in parallel to each other) and may be substantially parallel to each other. In general, it is considered that, in an assembly process of a liquid crystal display device, the amount of misalignment in the rotational direction between a liquid crystal panel and a polarizer is within approximately 5°. Therefore, the azimuth angle directions Vs in which the diffusibility of the light dispersion member 7 becomes relatively great and the short sides of the substrate 39 may be said to be substantially parallel to each other even in the case in which the azimuth angle directions Vs and the short sides of the substrate 39 are misaligned approximately 5° from each other.

The configuration of the light dispersion member 7 is not necessarily limited to the above-described configuration in which all the azimuth angle directions of the light diffusion portion 40 are aligned in one direction, and the light dispersion member 7 may have, for example, a configuration in which a light diffusion portion having different azimuth angle directions of azimuthal anisotropy is included. In this case, having different azimuth angle directions of azimuthal anisotropy enables the improvement direction of viewing angle characteristic for the liquid crystal panel 4 to be diversified.

The buffer layer 8 is a component that, by elastically deforming when pressure is applied from the substrate 39 side, relaxes pressure applied to the light diffusion portion 40. The buffer layer 8 is formed on the surface (light incident end surface 40b) on the opposite side of the light diffusion portion 40 to the surface thereof facing the substrate 39. The buffer layer 8 has a lower compressive elastic modulus than the light diffusion portion 40. Due to this characteristic, when an external force is applied from the substrate 39 side, the buffer layer 8 is more likely to deform than the light diffusion portion 40, which enables deformation of the light diffusion portion 40 to be suppressed.

As a material of the buffer layer 8, for example, acrylic transparent resin, polyolefinic elastomer, silicone-based resin, urethane-based resin, rubber, or the like may be used. It is preferable to use a material that has a function (adhesion) as an adhesion layer (an adhesive) among the above materials. Using such a material, it is possible to make the buffer layer 8 adhere to the surface (light incident end surface 40b) on the opposite side of the light diffusion portion 40 to the surface thereof facing the substrate 39.

For the buffer layer-containing light dispersion member 100, it is possible to laminate the light dispersion member 7 to the liquid crystal panel 4 with the buffer layer 8 interposed therebetween. In this case, since no air layer exists at the boundary face between the buffer layer 8 and the liquid crystal panel 4, it is possible to achieve a reduction in loss of light due to boundary face reflection.

Furthermore, in the buffer layer-containing light dispersion member 100, it is preferable that the thickness of the buffer layer 8 is smaller than the height of the air-cavities 42. The height of the air-cavities 42 means the height of each air-cavity (space) 42, which is formed between the light diffusion portion 40 and a light shielding layer 41, from the light shielding layer 41 to the light incident end surface 40b. In this case, even if the buffer layer 8 that has deformed due to an applied external force intrudes into the spaces (air-cavities 42) surrounded by the light diffusion portion 40, there is no possibility that the spaces are filled completely, which enables reflection characteristics at the side surfaces 40c of the light diffusion portion 40 to be maintained.

It is preferable that the buffer layer 8 has a lower refractive index than the light diffusion portion 40. In this case, since incrementally changing refractive indices produce lower reflection ratios at respective boundary faces than rapidly changing refractive indices, it is possible to increase use efficiency of light in the light dispersion member 7.

The buffer layer 8 may have optical transparency to ultraviolet light (UV light). In this case, in the after-mentioned forming step of the light diffusion portion 40, after radiating ultraviolet light (UV light) from the substrate 39 side onto a dry film resist (photo-sensitive resin layer) to be formed into the light diffusion portion 40 and performing exposure (patterning) using the light shielding layers 41 as a mask, radiating ultraviolet light (UV light) from the light incident end surface 40b side, which does not hide behind the light shielding layers 41, while protecting the light diffusion portion 40 by the buffer layer 8 laminated on the dry film resist enables the light diffusion portion 40 to be main-cured (post-cured) evenly.

In the case in which the buffer layer-containing light dispersion member 100 is produced by the after-mentioned roll-to-roll (RtoR) method, the buffer layer 8 is capable of relaxing pressure applied to the light diffusion portion 40 of the light dispersion member 7 in the buffer layer-containing light dispersion member 100 that is wound in a roll shape and thereby preventing the light diffusion portion 40 from deforming.

As illustrated in FIG. 1, the buffer layer-containing light dispersion member 100 that has the configuration described above is disposed on the viewing side of the liquid crystal display unit 6. That is, with the substrate 39 located at the most outer surface facing the viewing side, the buffer layer 8 is laminated to the second polarizer 5.

In the liquid crystal display device 1, disposing the buffer layer-containing light dispersion member 100 of the embodiment on the viewing side of the liquid crystal display unit 6 enables the viewing angle to be extended while dispersing light emitted from the viewing side of the liquid crystal display unit 6.

In the liquid crystal display device 1, disposing the buffer layer-containing light dispersion member 100 of the embodiment on the viewing side of the liquid crystal display unit 6 enables pressure applied to the light dispersion member 7 to be relaxed by the buffer layer 8 elastically deforming due to pressure applied from the light dispersion member 7 side even in the case in which a force is applied to the light dispersion member 7 from the outside.

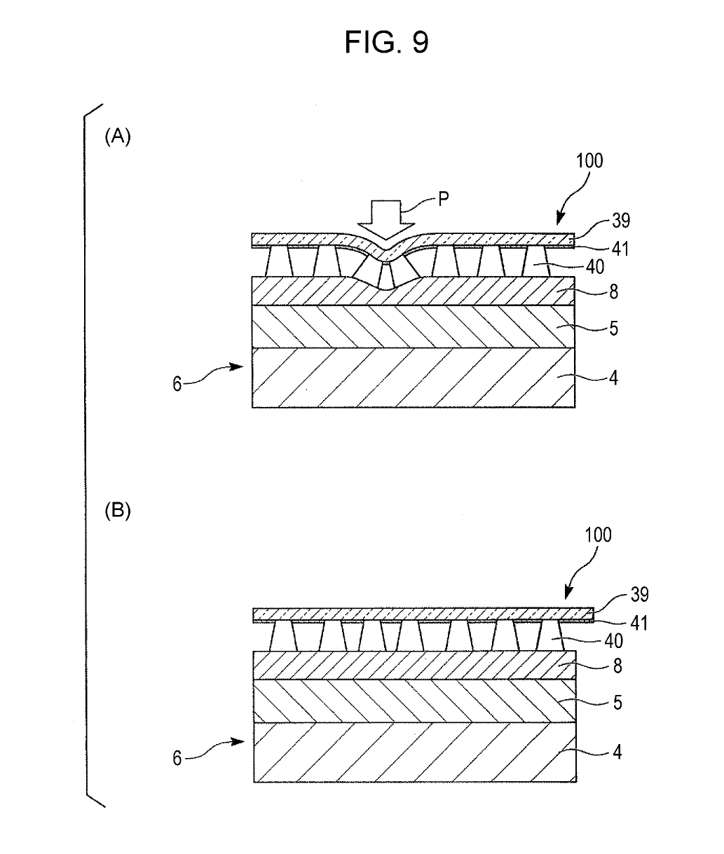

A state in which an external force P is applied to the buffer layer-containing light dispersion member 100 is illustrated in FIG. 9(A). A state in which the external force P that has been applied to the buffer layer-containing light dispersion member 100 is removed is illustrated in FIG. 9(B).

As illustrated in FIG. 9(A), in the buffer layer-containing light dispersion member 100, when the external force P is applied from the light dispersion member 7 side, the buffer layer 8 elastically deforms due to pressure applied from the substrate 39 side. At this time, since pressure applied to the light diffusion portion 40 is relaxed, deformation of the light diffusion portion 40 is suppressed.

On the other hand, as illustrated in FIG. 9(B), after the external force P that has been applied is removed, the buffer layer 8 elastically returns. Due to this action, the buffer layer-containing light dispersion member 100 returns to a state before the external force P is applied. The light diffusion portion 40 also maintains the form thereof without being deformed from the original solid form.

When it is assumed that a longitudinal modulus of elasticity of the light diffusion portion 40 is denoted by E1 and a longitudinal modulus of elasticity of the buffer layer 8 is denoted by E2, a strain ε1 in the light diffusion portion 40 and a strain ε2 in the buffer layer 8 when the external force P is applied can be calculated by the formulae (1) and (2) below, respectively.

ε1=P/E1 (1)

ε2=P/E2 (2)

Each of the strains ε1 and ε2 is a value obtained by dividing a thickness after the external force P is applied by an original thickness before the external force P is applied.

From the above formulae (1) and (2), E1/E2=ε2/ε1 is obtained.

The light diffusion portion 40 and the buffer layer 8 are required to return to the original forms instead of plastically deforming after the external force P is removed. Therefore, in the case in which a quantity of strain at which elastic deformation of the light diffusion portion 40 changes to a deformation including plastic deformation is denoted by ε1max and a quantity of strain at which elastic deformation of the buffer layer 8 changes to a deformation including plastic deformation is denoted by ε2max, to satisfy at least the relation E1>E2, the relation ε1max<ε2max is required to hold.

The solid form of the light diffusion portion 40 is designed to be an optimum form that enables an improvement effect in the viewing angle of the liquid crystal display device 1 to be obtained. Thus, in the case in which a large force applied from the outside causes a deformation in the form of the light diffusion portion 40, there is a possibility that it becomes impossible to obtain a sufficient improvement effect in the viewing angle.

On the other hand, in the buffer layer-containing light dispersion member 100 of the embodiment, since the buffer layer 8 relaxes pressure applied from the outside, it is possible to maintain the light dispersion function while preventing the light diffusion portion 40 from plastically deforming.

### Method for Producing Buffer Layer-Containing Light Dispersion Member

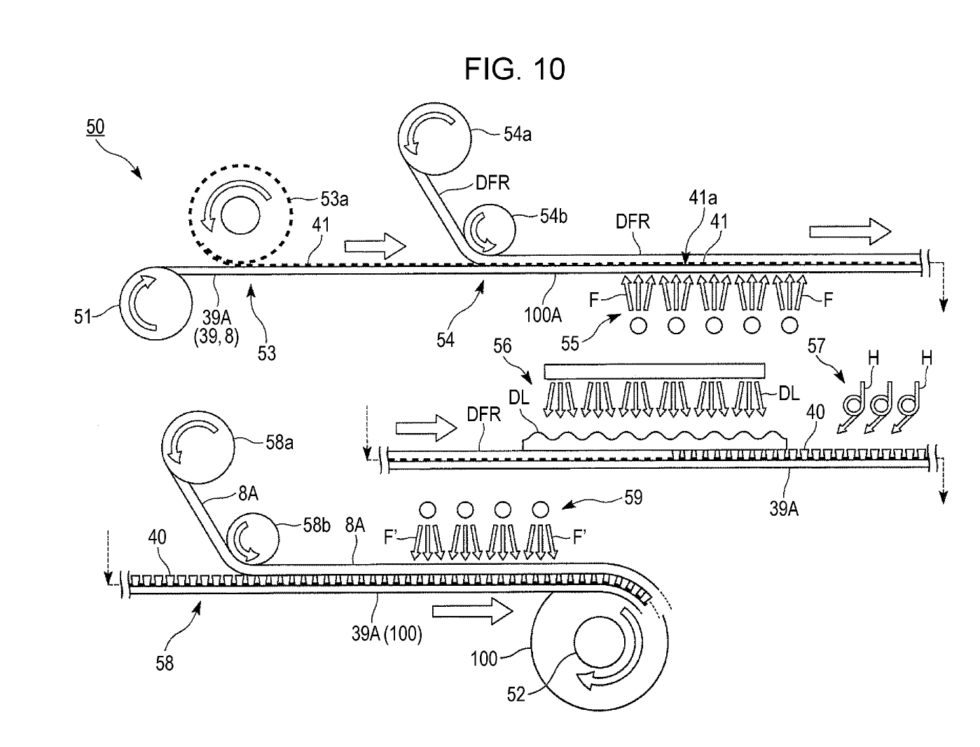

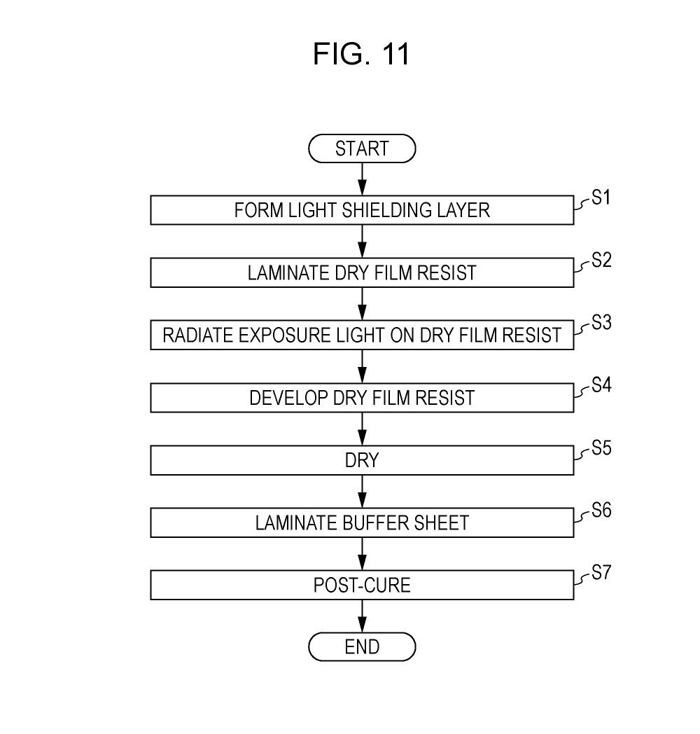

Next, a method for producing the buffer layer-containing light dispersion member 100 will be described with reference to FIGS. 10 and 11.

FIG. 10 is a side view illustrating a configuration of a production apparatus 50 of the buffer layer-containing light dispersion member 100. FIG. 11 is a flowchart illustrating a production process of the buffer layer-containing light dispersion member 100.

As illustrated in FIG. 10, the production apparatus 50 is an apparatus that transfers a long substrate sheet 39A, which is to be formed into the substrate 39, in a roll-to-roll (RtoR) manner, and performs various processing during the transfer. The production apparatus 50 uses a printing method to form the light shielding layer 41.

The production apparatus 50 is configured to, by having a feeding roller 51 feeding the substrate sheet 39A disposed at one end side and a winding roller 52 winding the substrate sheet 39A disposed at the other end side, transfer (move) the substrate sheet 39A from the feeding roller 51 side toward the winding roller 52 side.

On the transfer path of the substrate sheet 39A, a printing apparatus 53, a first lamination apparatus 54, an exposure apparatus 55, a development apparatus 56, a drying apparatus 57, a second lamination apparatus 58, and a curing apparatus 59 are placed successively from the feeding roller 51 side toward the winding roller 52 side.

The printing apparatus 53 is an apparatus that forms a plurality of light shielding layers 41 on the substrate sheet 39A by gravure printing. The first lamination apparatus 54 is an apparatus that laminates a negative dry film resist (photo-sensitive resin layer) DFR on the substrate sheet 39A on which the plurality of light shielding layers 41 have been formed. The exposure apparatus 55 is an apparatus that performs exposure of the dry film resist DFR by radiating exposure light F from the substrate sheet 39A side. The development apparatus 56 is an apparatus that develops the dry film resist DFR after exposure by developer DL. The drying apparatus 57 is an apparatus that dries the substrate sheet 39A on which the light diffusion portion 40, which is made of the dry film resist DFR after development, has been formed. The second lamination apparatus 58 is an apparatus that laminates a long buffer layer sheet 8A, which is to be formed into the buffer layer 8, on the substrate sheet 39A on which the light diffusion portion 40 has been formed. The curing apparatus 59 is an apparatus that performs curing (post-curing) of the light diffusion portion 40 by radiating ultraviolet light (UV light) F′ onto the substrate sheet 39A on which the light diffusion portion 40 has been formed.

In the case of producing the buffer layer-containing light dispersion member 100 using the above-described production apparatus 50, first, a plurality of light shielding layers 41 are formed on one surface of the substrate sheet 39A by gravure printing in step S1 illustrated in FIG. 11. Specifically, as illustrated in FIG. 10, with a printing roller 53a included in the printing apparatus 53 being rotated on the surface of the substrate sheet 39A in the direction identical to the transfer direction of the substrate sheet 39A, a light shielding layer material to be formed into the light shielding layers 41 is transferred. With this processing, a plurality of light shielding layers 41 can be formed on one surface of the substrate sheet 39A collectively.

For example, the planar shapes of the light shielding layers 41 are ellipses, and the thickness of the light shielding layers 41 is 150 nm. A region other than the light shielding layers 41 forms an opening portion 41a that corresponds to a region to which the light diffusion portion 40 is to be formed in the next step. An arrangement of gaps (pitches) between adjacent light shielding layers 41 is neither regular nor periodic. It is desirable that gaps (pitches) between light shielding layers 41 are smaller than a gap (pitch, for example, 150 μm) between pixels in the liquid crystal panel 2. With this arrangement, at least one light shielding layer 41 is formed within a pixel. In consequence, even when combined with, for example, a liquid crystal panel having a small pixel pitch, which is used for a mobile device or the like, it is possible to achieve a wide viewing angle uniformly within a screen.

Although, in the embodiment, the light shielding layers 41 are formed using gravure printing, without being limited to the method, gravure offset printing may be used. In addition, it is also possible to form the light shielding layers 41 by a photolithography method using a black negative resist. In this case, use of a photomask in which an opening pattern and a light-shielding pattern are reversed from each other enables a positive resist with light absorbency to be used. Alternatively, the light shielding layers 41 may be formed directly using a vapor deposition method, an inkjet method, or the like.

Next, in step S2 illustrated in FIG. 11, on the substrate sheet 39A on which the plurality of light shielding layers 41 have been formed, a dry film resist DFR is laminated. Specifically, as illustrated in FIG. 10, a dry film resist DFR is fed out of a feeding roller 54a included in the first lamination apparatus 54, and, with a laminating roller 54b being rotated in the direction identical to the transfer direction of the substrate sheet 39A, the dry film resist DFR of a thickness of, for example, approximately 20 μm is laminated on one surface of the substrate sheet 39A.

Although illustration is omitted, the dry resist film DFR before lamination has a structure in which a photo-sensitive resin layer is sandwiched between a protective film and a substrate film. In the case in which the dry resist film DFR is laminated on the substrate sheet 39A, after the protective film is separated from the photo-sensitive resin layer, the dry resist film DFR is laminated in such a way that the photo-sensitive resin layer comes into contact with the substrate sheet 39A.

With this processing, an intermediate article 100A is obtained in which the plurality of light shielding layers 41 and the dry film resist (photo-sensitive resin layer) DFR covering the surface on which the light shielding layers 41 are formed are formed on one surface of the substrate sheet 39A (substrate 39).

Next, in step S3 illustrated in FIG. 11, exposure of the dry film resist DFR of the intermediate article 100A is performed. Specifically, as illustrated in FIG. 10, exposure light F emitted from a plurality of light sources 55a included in the exposure apparatus 55 is radiated from the substrate sheet 39A side. With this radiation, it is possible to perform exposure of the dry film resist DFR using the light shielding layers 41 as a mask. At this time, ultraviolet light (UV light) is used as the exposure light F. In the embodiment, exposure using a mixed ray of an i-ray with a wavelength of 365 nm, an h-ray with a wavelength of 404 nm, and a g-ray with a wavelength of 436 nm is performed. The amount of exposure is set at 500 mJ/cm².

In the embodiment, it is preferable to use diffused light as exposure light F suitable for performing exposure of the dry film resist DFR. The dry film resist DFR is exposed by such dispersed exposure light F in such a way that a radiated area radially spreads outward from the region where the light shielding layers 41 are not formed (opening portion 41a). With this processing, the side surfaces 40c of the light diffusion portion 40 can be formed to be inclined faces that are inclined in an inversely tapered manner from the substrate 39 side toward the opposite side to the substrate 39.

The exposure light F may change the intensity thereof in such a way that, for example, as the substrate sheet 39A moves, the intensity of the exposure light F gradually weakens. As the substrate sheet 39A moves, the emission angle of the exposure light F may gradually change. The exposure light F may be light produced by dispersing parallel light by a diffuser. Using such methods enables the taper angle of the side surfaces 40c of the light diffusion portion 40 to be controlled to a desirable angle.

Next, in step S4 illustrated in FIG. 11, development is performed for the dry film resist DFR after exposure. Specifically, as illustrated in FIG. 10, the development apparatus 56 coats developer DL onto the dry film resist DFR after exposure. With this processing, unexposed portions of the dry film resist DFR are removed, and the light diffusion portion 40 is formed on one surface of the substrate sheet 39A. Although illustration is omitted, before the developer is coated, the substrate film of the above-described dry film resist DFR is separated from the upper surface of the photo-sensitive resin layer of the dry film resist DFR.

Next, in step S5 illustrated in FIG. 11, drying of the substrate sheet 39A on which the light diffusion portion 40 has been formed is performed. Specifically, as illustrated in FIG. 10, the drying apparatus 57 performs drying of the light diffusion portion 40 by blowing hot warm air H with a temperature of 50° C. from the light diffusion portion 40 side of the substrate sheet 39A. Drying by a hot plate or infrared ray radiation may be performed in the drying step.

Next, in step S6 illustrated in FIG. 11, the buffer layer sheet 8A is laminated on the substrate sheet 39A on which the light diffusion portion 40 has been formed. Specifically, as illustrated in FIG. 10, the buffer layer sheet 8A is fed out of a feeding roller 58a included in the second lamination apparatus 58, and, with a laminating roller 59b being rotated in the direction identical to the transfer direction of the substrate sheet 39A, the buffer layer sheet 8A of a thickness of, for example, approximately 15 μm is laminated on one surface of the substrate sheet 39A. Although illustration is omitted, the buffer layer sheet 8A before lamination has a structure in which the buffer layer is sandwiched between a protective film and a substrate film. In the case in which the buffer layer sheet 8A is laminated to the substrate sheet 39A, after the protective film is separated from the buffer layer, the buffer layer sheet 8A is laminated in such a way that the buffer layer comes into contact with the light diffusion portion.

Next, in step S7 illustrated in FIG. 11, curing (post-curing) of the light diffusion portion 40 is performed. Specifically, as illustrated in FIG. 10, radiating ultraviolet light (UV light) F′ emitted from a plurality of light sources 59a included in the curing apparatus 59 from the light diffusion portion 40 side of the substrate sheet 39A cures the light diffusion portion 40.

By applying the steps described above, a long buffer layer-containing light dispersion member 100 can be obtained. The buffer layer-containing light dispersion member 100 is, after being wound on the winding roller 52 only in a predetermined quantity, transferred to a next step.

In the embodiment, since the exposure light F is radiated using the light shielding layers 41 as a mask in the above-described step to form the light diffusion portion 40, the light diffusion portion 40 is formed being self-aligned with the position of the opening portion 41a between the light shielding layers 41. As a result, the light diffusion portion 40 becomes in close contact with the light shielding layers 41 and no gap is produced therebetween, which enables a light transmittance to be surely maintained. Moreover, since accurate alignment work is not required, it is possible to shorten a time required for production.

In the embodiment, radiating ultraviolet light (UV light) from the light incident end surface 40b side that does not hide behind the light shielding layers 41 with the light diffusion portion 40 being protected by the buffer layer sheet 8A laminated to the dry film resist DFR (light diffusion portion 40) enables the light diffusion portion 40 to be main-cured (post-cured) evenly.

In the embodiment, when the buffer layer-containing light dispersion member 100 is produced by a roll-to-roll (RtoR) method, since pressure applied to the light diffusion portion 40 of the light dispersion member 7 can be relaxed by the buffer layer sheet 8A in the buffer layer-containing light dispersion member 100 wound in a roll shape, it is possible to maintain a light dispersion function of the light diffusion portion 40 while preventing the light diffusion portion 40 from plastically deforming.

In the embodiment, a step to laminate an optical sheet to be formed into the second polarizer 5 to the produced long buffer layer-containing light dispersion member 100 may be further appended. With this processing, it is possible to form the buffer layer-containing light dispersion member 100 and the second polarizer 5 in one body.

As illustrated in FIG. 1, the produced buffer layer-containing light dispersion member 100, after being cut into a predetermined size in accordance with the liquid crystal panel 4, is laminated to the liquid crystal display unit 6. That is, with the substrate 39 facing the viewing side and the buffer layer 8 facing the second polarizer 5, the buffer layer-containing light dispersion member 100 is laminated to the second polarizer 5.

By applying the steps described above, the liquid crystal display device 1 can be produced.

### Second Embodiment

### Liquid Crystal Display Device

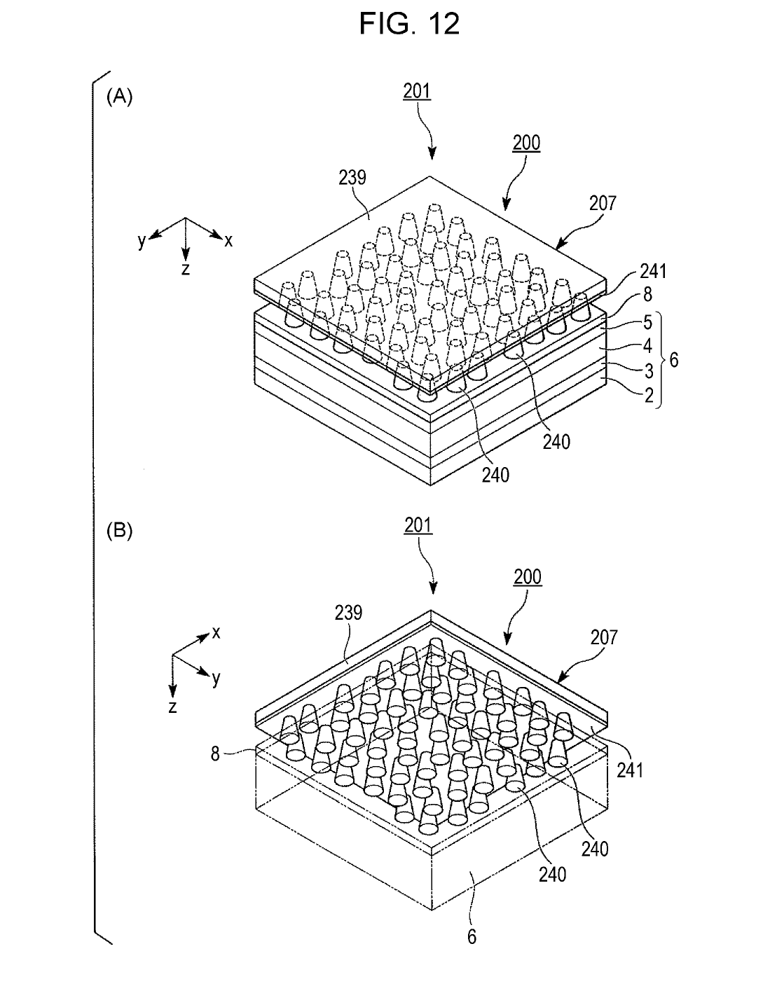

Next, as a second embodiment, a liquid crystal display device 201 illustrated in FIGS. 12(A) and (B) will be described.

FIG. 12(A) is a perspective view of the liquid crystal display device 201 when viewed from the upper side. FIG. 12(B) is a perspective view of the liquid crystal display device 201 when viewed from the lower side.

The liquid crystal display device 201 illustrated in FIGS. 12(A) and (B) has basically the same configuration as the above-described liquid crystal display device 1 except including a buffer layer-containing light dispersion member 200 the configuration of which is different from the configuration of the above-described buffer layer-containing light dispersion member 100. Therefore, in the following description, the configuration of the buffer layer-containing light dispersion member 200 will be described. A description of the same components as the components in the above-described liquid crystal display device 1 and buffer layer-containing light dispersion member 100 will be omitted, and the same reference characters will be assigned thereto in drawings.

### Buffer Layer-Containing Light Dispersion Member

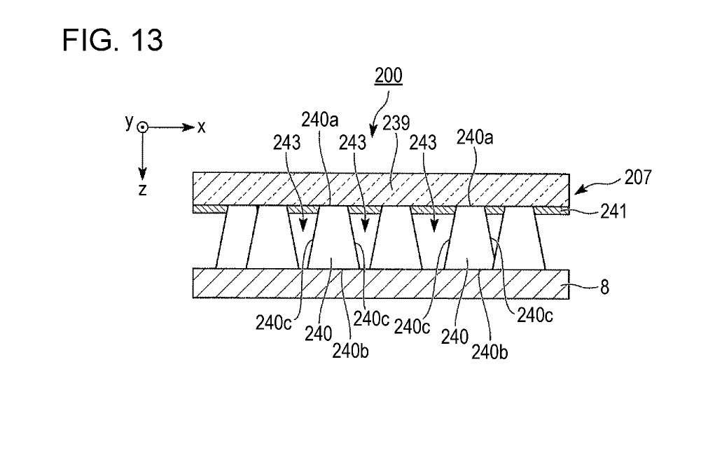

Next, a specific configuration of the buffer layer-containing light dispersion member 200 will be described with reference to FIG. 13.

FIG. 13 is a cross-sectional view illustrating a schematic configuration of the buffer layer-containing light dispersion member 200.

As illustrated in FIG. 13, the buffer layer-containing light dispersion member 200 is composed of a light dispersion member 207 and a buffer layer 8 that are formed in one body.

The light dispersion member 207 includes a substrate 239 that has optical transparency, a plurality of light diffusion portions 240 that are formed on one surface (the opposite surface to the viewing side) of the substrate 239, and a light shielding layer (light absorbing portion) 241, and has a structure in which, within a region where the light shielding layer 241 is formed, the light diffusion portions 240 are arranged separately into a plurality of regions. That is, the buffer layer-containing light dispersion member 200 has a configuration in which the region where the light diffusion portion 40 included in the above-described buffer layer-containing light dispersion member 100 is formed and the regions where the light shielding layers 41 included therein are formed are reversed.

It is preferable to use transparent resin film, such as triacetyl cellulose (TAC) film, polyethylene terephthalate (PET), polycarbonate (PC), polyethylene naphthalate (PEN), and polyether sulphone (PES) film, for the substrate 239. The substrate 239 is to be used as a base layer in the case of coating materials for the light shielding layer 241 and the light diffusion portions 240, and is thus required to have heat resistance and mechanical strength in a heat treatment step in a production process. Therefore, for the substrate 239, not only a substrate made of resin but also a substrate made of glass or the like may be used. However, it is preferable that the thickness of the substrate 239 is set thin to an extent not impairing heat resistance and mechanical strength. That is because, the thicker the thickness of the substrate 239 becomes, the higher possibility of producing a blur to a display is caused. In the embodiment, as an example of the substrate 239, a transparent resin film of a thickness of 100 μm is used. It is also preferable that the total light transmittance of the substrate 239 is 90% or higher in accordance with the provisions of JIS K7361-1. Setting the total light transmittance at 90% or higher enables sufficient transparency to be obtained.

The plurality of light diffusion portions 240 are portions that contribute to the transmission of light in the light dispersion member 207, and are arranged at non-periodical when viewed from the normal direction of the principal face of the substrate 239. The plurality of light diffusion portions 240 are made of an organic material that has optical transparency and photosensitivity, such as acrylic resin and epoxy resin. It is preferable that the total light transmittance of the light diffusion portions 240 is 90% or higher in accordance with the provisions of JIS K7361-1. Setting the total light transmittance at 90% or higher enables sufficient transparency to be obtained.

With regard to each light diffusion portion 240, a horizontal cross section (xy cross-section) thereof has a circular shape, the area of a face 240a thereof on the substrate 239 side (referred to as a light emitting end surface) is small, the area of a face 240b thereof on the opposite side to the substrate 239 (referred to as a light incident end surface) is large, and the areas of horizontal cross sections thereof gradually increase from the substrate 239 side toward the opposite side to the substrate 239. Thus, each light diffusion portion 240 is shaped in a circular conical frustum the side face 240c of which is inclined in an inversely tapered manner from the substrate 239 side toward the opposite side to the substrate 239.

The angle of inclination of the side face 240c of each light diffusion portion 240 (an angle formed by the light incident end surface 240b and the side face 240c thereof) is, as an example, approximately 80°. However, the angle of inclination of the side face 240c of each light diffusion portion 240 is not limited to a specific value as long as the angle of inclination is an angle that enables incident light to be sufficiently dispersed in the case of emitting the light from the light dispersion member 207.

The light shielding layer 241 is a layer that shields (absorbs) light leaking out from the side surfaces 240c of the light diffusion portions 240, and is formed in a continuous manner in a region other than the regions where the light diffusion portions 240 are formed within the surface on the side of the substrate 239 at which the light diffusion portions 240 are formed. The light shielding layer 241 is, as an example, made of an organic material having light absorbency and photosensitivity, such as black resist. In addition, for the light shielding layer 241, for example, metal film, such as chromium (Cr) and multilayer film of Cr and Cr oxide, may be used.

The layer thickness of the light shielding layer 241 is set smaller than the height of the light diffusion portions 240 from the light incident end surfaces 240b to the light emitting end surfaces 240a. In the case of the embodiment, the layer thickness of the light shielding layer 241 is, as an example, approximately 150 nm, and the height of the light diffusion portions 240 from the light incident end surfaces 240b to the light emitting end surfaces 240a is, as an example, approximately 25 μm. Thus, a space 243 is formed between the light diffusion portions 240 and the light shielding layer 241, and an air layer exists within the space 243.

It is desirable that the refractive index of the substrate 239 is substantially the same as the refractive index of the light diffusion portions 240. That is because there is a possibility that, if the refractive index of the substrate 239, for example, greatly differs from the refractive index of the light diffusion portions 240, in the case in which light that is incident to the light incident end surfaces 240b is emitted from the light diffusion portions 240, unnecessary refraction and reflection of light are caused at the boundary faces between the light diffusion portions 240 and the substrate 239, causing problems in that a desirable viewing angle is not obtained, the quantity of emitted light decreases, and so on.

The buffer layer-containing light dispersion member 200 is composed of the light dispersion member 207 and the buffer layer 8 that are formed in one body. That is, the buffer layer 8 is formed on the surface (light incident end surfaces 240b) on the opposite side of the light diffusion portions 240 to the surface thereof facing the substrate 239.

The buffer layer-containing light dispersion member 200 that has the configuration described above is disposed on the viewing side of a liquid crystal display unit 6. That is, with the substrate 239 located at the most outer surface facing the viewing side, the buffer layer 8 is laminated to a second polarizer 5.

In the liquid crystal display device 201, disposing the buffer layer-containing light dispersion member 200 of the embodiment on the viewing side of the liquid crystal display unit 6 enables light emitted from the viewing side of the liquid crystal display unit 6 to be dispersed to extend the viewing angle.

In the liquid crystal display device 201, disposing the buffer layer-containing light dispersion member 200 of the embodiment on the viewing side of the liquid crystal display unit 6 enables the buffer layer 8 to relax pressure applied to the light dispersion member 207 by elastically deforming due to pressure applied from the light dispersion member 207 side even in the case in which a force is applied to the light dispersion member 207 from the outside. With this feature, it is possible to prevent light dispersion performance (optical properties) of the light dispersion member 207 from deteriorating while preventing the light dispersion member 207 from deforming.

### Third Embodiment

### Liquid Crystal Display Device

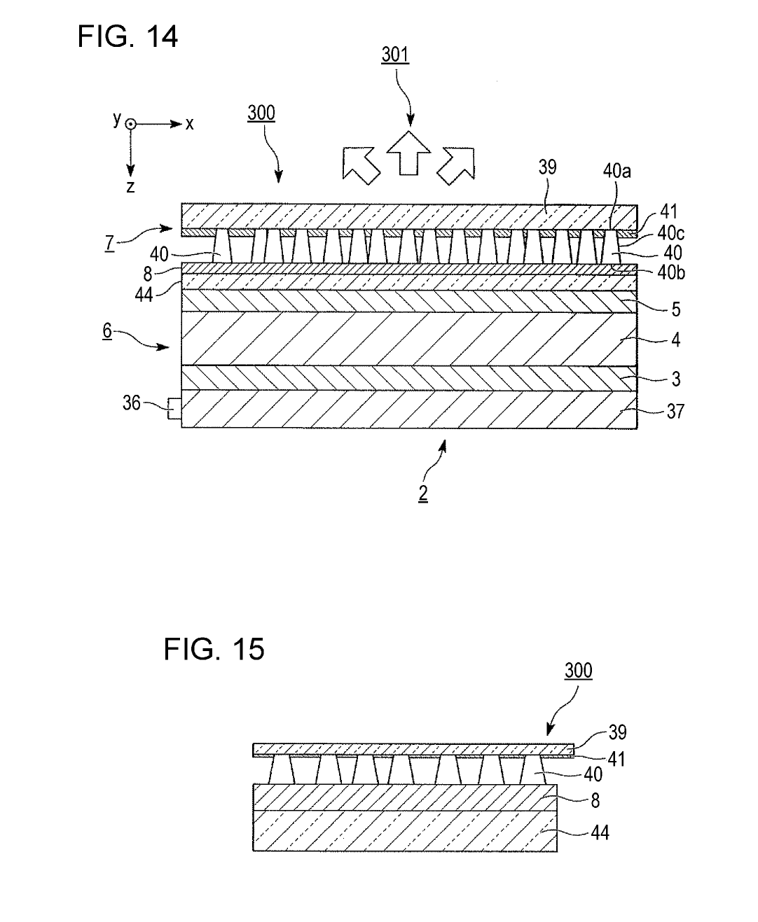

Next, as a third embodiment, a liquid crystal display device 301 illustrated in FIG. 14 will be described.

FIG. 14 is a cross-sectional view illustrating a schematic configuration of the liquid crystal display device 301.

The liquid crystal display device 301 illustrated in FIG. 14 has basically the same configuration as the above-described liquid crystal display device 1 except including a buffer layer-containing light dispersion member 300 the configuration of which is different from the configuration of the above-described buffer layer-containing light dispersion member 100. Therefore, in the following description, the configuration of the buffer layer-containing light dispersion member 300 will be described. A description of the same components as the components in the above-described liquid crystal display device 1 and buffer layer-containing light dispersion member 100 will be omitted, and the same reference characters will be assigned thereto in drawings.

### Buffer Layer-Containing Light Dispersion Member

Next, a specific configuration of the buffer layer-containing light dispersion member 300 will be described with reference to FIG. 15.

FIG. 15 is a cross-sectional view illustrating a schematic configuration of the buffer layer-containing light dispersion member 300.

As illustrated in FIG. 15, the buffer layer-containing light dispersion member 300 has a configuration in which a substrate 44 having optical transparency is further formed on the surface on the opposite side of a buffer layer 8 to the surface thereof facing a light dispersion member 7 (light diffusion portion 40). For the substrate 44, a substrate made of the same material as the above-described substrate 39 may be used. The substrate 44 is adhered to the surface on the opposite side of the buffer layer 8 to the surface thereof facing the light diffusion portion 40. That is, the light dispersion member 7 and the buffer layer 8 are disposed in such a way as to be sandwiched between the substrate 39 on one side and the substrate 44 on the other side.

The substrate 44 has a higher compressive elastic modulus than the buffer layer 8 to protect the buffer layer 8. With this configuration, the buffer layer-containing light dispersion member 300 is capable of preventing the buffer layer 8 from being damaged even in the case in which an external force is applied from the substrate 44 side.

The buffer layer-containing light dispersion member 300 that has the configuration described above is disposed on the viewing side of a liquid crystal display unit 6. That is, with the substrate 39 located at the most outer surface facing the viewing side, the substrate 44 is laminated to a second polarizer 5 with an adhesion layer (not illustrated) interposed therebetween. The adhesion layer may be an adhesion layer that is re-adherable even in the case of being separated after lamination.

In the liquid crystal display device 301, disposing the buffer layer-containing light dispersion member 300 of the embodiment on the viewing side of the liquid crystal display unit 6 enables light emitted from the viewing side of the liquid crystal display unit 6 to be dispersed to extend the viewing angle.

In the liquid crystal display device 301, disposing the buffer layer-containing light dispersion member 300 of the embodiment on the viewing side of the liquid crystal display unit 6 enables the buffer layer 8 to relax pressure applied to the light dispersion member 7 by elastically deforming due to pressure applied from the light dispersion member 7 side even in the case in which a force is applied to the light dispersion member 7 from the outside. With this feature, it is possible to prevent light dispersion performance (optical properties) of the light dispersion member 7 from deteriorating while preventing the light dispersion member 7 from deforming.

Although the buffer layer-containing light dispersion member 300 has a configuration in which the substrate 44 is further added to the configuration of the buffer layer-containing light dispersion member 100 described in the above-described first embodiment, even a configuration in which the substrate 44 is further added to the configuration of the buffer layer-containing light dispersion member 200 described in the above-described second embodiment enables the same advantageous effects as the above-described buffer layer-containing light dispersion member 300 to be obtained.

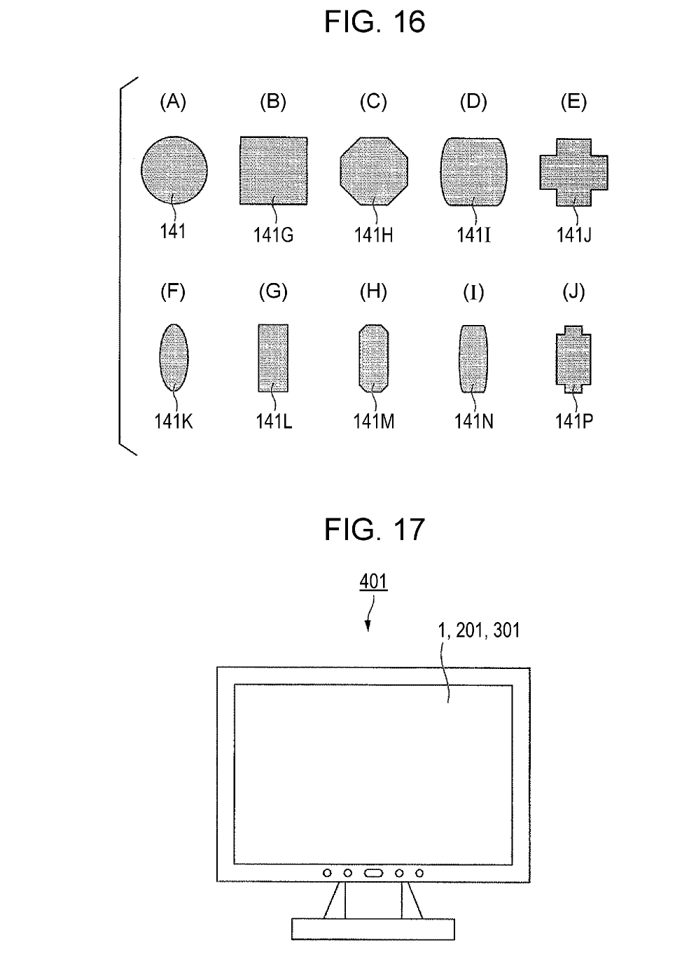

Although, in the above-described first embodiment, an example of a light shielding layer 41 the planar shape of which is an ellipse was described, a light shielding layer 141 the planar shape of which is, as illustrated in FIG. 16(A), a circle may be used. Alternatively, a light shielding layer 141G the planar shape of which is, as illustrated in FIG. 16(B), a square may be used. Alternatively, a light shielding layer 141H the planar shape of which is, as illustrated in FIG. 16(C), a regular octagon may be used. Alternatively, a light shielding layer 141I the shape of which is, as illustrated in FIG. 16(D), a shape in which two opposing sides of a square are excurved may be used. Alternatively, a light shielding layer 141I the shape of which is, as illustrated in FIG. 16(E), a shape in which two rectangles are crossed over each other in two directions intersecting at right angles may be used. Alternatively, a light shielding layer 141K the shape of which is, as illustrated in FIG. 16(F), an elongated elliptical shape may be used. Alternatively, a light shielding layer 141L the shape of which is, as illustrated in FIG. 16(G), an elongated rectangle may be used. Alternatively, a light shielding layer 141M the shape of which is, as illustrated in FIG. 16(H), an elongated octagon may be used. Alternatively, a light shielding layer 141N the shape of which is, as illustrated in FIG. 16(I), a shape in which two opposing sides of an elongated rectangle are excurved may be used. Alternatively, a light shielding layer 141P the shape of which is, as illustrated in FIG. 16(J), a shape in which two rectangles with different aspect ratios are crossed over each other in two directions intersecting at right angles may be used. Furthermore, the shapes in FIGS. 16(A) to (J) may be rotated in a plurality of directions.

In the case in which each light shielding layer is a circular light shielding layer 141 illustrated in FIG. 16(A), the cross-sectional shape of each side face of the light diffusion portion is also a circle. Thus, light reflected by each side face of the light diffusion portion is dispersed in all 360 degrees azimuthal direction. On the other hand, in the case in which each light shielding layer is, for example, a square-shaped light shielding layer 141G illustrated in FIG. 16(B), light is dispersed in the directions perpendicular to the respective sides of the square. In the case in which each light shielding layer is a rectangular light shielding layer 141L illustrated in FIG. 16(G), light dispersion in the directions perpendicular to the long sides becomes more intense than light dispersion in the directions perpendicular to the short sides. Thus, it is possible to achieve a light dispersion sheet in which intensities of light dispersion are different between dispersion in the vertical directions (up and down directions) and dispersion in the horizontal directions (right and left directions) depending on the lengths of the sides. In the case in which each light shielding layer is an octagonal light shielding layer 141H illustrated in FIG. 16(C), it is possible to disperse light in a concentrated manner in the vertical directions, the horizontal directions, and the directions at an inclination angle of 45 degrees, which are particularly regarded as important for the viewing angle characteristic of a liquid crystal display device. As described above, in the case in which viewing angle anisotropy is required, appropriately changing the shapes of light shielding portions enables different light dispersion characteristics to be obtained.

In the light shielding layers 41, such light shielding layers of different shapes may be included. Portions of the light shielding layers 41 may be formed in an overlapping manner.

Although, in the above-described second embodiment, as a configuration in which the region where the light diffusion portion 40 is formed and the regions where the light shielding layers 41 are formed are reversed, an example of the light diffusion portions 240 the planar shapes of which are circles was described, it is also possible to apply the same change as the above-described change in the planar shapes of the light shielding layers 41 to the planar shapes of the light diffusion portions 240.

### Fourth Embodiment

### Liquid Crystal Display Device

Next, as a fourth embodiment, a liquid crystal television 401 illustrated in FIG. 17 will be described.

FIG. 17 is a front view illustrating a schematic configuration of the liquid crystal television 401, which is a configuration example of a display device.

The liquid crystal television 401 illustrated in FIG. 17 becomes a high resolution liquid crystal television by being provided with one of the liquid crystal display devices 1, 201, and 301 of the above-described embodiments.

It is possible to apply the liquid crystal display devices 1, 201, and 301 of the embodiments to not only the liquid crystal television 401 described above but also display portions of for example, personal computers, mobile phones, and so on.

### Fifth Embodiment

### Buffer Layer-Containing Light Dispersion Member

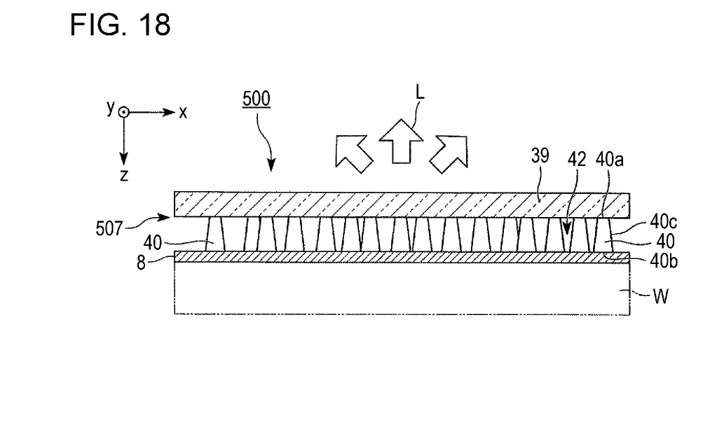

Next, as a fifth embodiment, a buffer layer-containing light dispersion member 500 illustrated in FIG. 18 will be described. FIG. 18 is a cross-sectional view illustrating a schematic configuration of the buffer layer-containing light dispersion member 500.

The buffer layer-containing light dispersion member 500 is used for a different purpose from that of the above-described buffer layer-containing light dispersion members 100, 200, and 300. That is, while the above-described buffer layer-containing light dispersion members 100, 200, and 300 are suitably used for the purpose of improving the viewing angles of the above-described liquid crystal display devices 1, 201, and 301, the buffer layer-containing light dispersion member 500 is suitably used for the purpose of improving indoor brightness while controlling the angle of incidence of outside light L incident through windowpanes W by laminating buffer layer-containing light dispersion members 500 on, for example, the inner surfaces of the windowpanes W of a building or the like.

The buffer layer-containing light dispersion member 500 has a configuration in which light shielding layers 41 included in the above-described light dispersion member 7 are omitted from the configuration of the above-described buffer layer-containing light dispersion member 100. With regard to a configuration other than the above feature, the buffer layer-containing light dispersion member 500 has basically the same configuration as the above-described buffer layer-containing light dispersion member 100. Thus, for the buffer layer-containing light dispersion member 500 illustrated in FIG. 18, a description of the same components as the components of the above-described buffer layer-containing light dispersion member 100 will be omitted, and the same reference characters will be assigned thereto in drawings.

As illustrated in FIG. 18, the buffer layer-containing light dispersion member 500 is composed of a light dispersion member 507 and a buffer layer 8 that are formed in one body.

The light dispersion member 507 includes a substrate 39 and a light diffusion portion 40 that is formed on one surface of the substrate 39, and has a structure in which, outside the region where the light diffusion portion 40 is formed, air-cavities 42 are disposed separately into a plurality of regions.

In the light dispersion member 507, controlling the azimuth angle direction of the light diffusion portion 40 having azimuthal anisotropy enables the angle of incidence of outside light L to be arbitrarily controlled.

The buffer layer 8, by elastically deforming when pressure is applied from the light dispersion member 507 side, relaxes pressure applied to the light dispersion member 507.

As illustrated in FIG. 18, the buffer layer 8 of the buffer layer-containing light dispersion member 500 that has the configuration described above is laminated to the inner surface of a windowpane W with the substrate 39 located at the most outer surface facing the indoor side.

In a building, disposing the buffer layer-containing light dispersion members 500 of the embodiment on windowpanes W enables the angle of incidence of outside light L incident through the windowpanes W to be controlled to improve indoor brightness.

In the buffer layer-containing light dispersion member 500 of the embodiment, the buffer layer 8 relaxes pressure applied to the light dispersion member 507 by elastically deforming due to pressure applied from the light dispersion member 507 side even in the case in which a force is applied to the light dispersion member 507 from the outside. With this feature, it is possible to prevent light dispersion performance (optical properties) of the light dispersion member 507 from deteriorating while preventing the light dispersion member 507 from deforming.

The buffer layer-containing light dispersion member 500 may have a configuration in which, as the above-described second embodiment, the region where the light diffusion portion 40 is formed and the regions where the air-cavities 42 are formed are reversed. That is, the buffer layer-containing light dispersion member 500 may have a configuration in which light diffusion portions 40 are arranged separately into a plurality of regions, and an air-cavity (space) 42 is formed in a continuous manner in a region other than the regions where the light diffusion portions 40 are formed.

The buffer layer-containing light dispersion member 500 may also have a configuration in which, as the above-described third embodiment, a substrate 44 is further formed on the surface on the opposite side of the buffer layer 8 to the surface thereof facing the light dispersion member 507 (light diffusion portion 40).

The present invention is not limited to the above embodiments and can be changed appropriately without departing from the spirit and scope of the present invention.

For example, although, in the above-described embodiments, an example of a liquid crystal display device including a liquid crystal panel 4 as a display unit was given, without being limited to the example, the present invention may be applied to a display device including an organic electroluminescent (EL) device, a plasma display, or the like as a display unit.

Although, in the above-described embodiments, an example in which the buffer layer-containing light dispersion member 100, 200, or 300 adheres onto the second polarizer 5 of the liquid crystal display unit 6 was described, neither the buffer layer-containing light dispersion member 100, 200, nor 300 has to be in contact with the liquid crystal display unit 6. For example, another optical film, optical component, or the like may be interposed between the buffer layer-containing light dispersion member 100, 200, or 300 and the liquid crystal display unit 6. Alternatively, the buffer layer-containing light dispersion member 100, 200, or 300 may be distanced from the liquid crystal display unit 6. Since, in the case of using an organic electroluminescent display device, a plasma display, or the like, no polarizer is required, neither the buffer layer-containing light dispersion member 100, 200, nor 300 is ever in contact with a polarizer.

Each of the buffer layer-containing light dispersion members 100, 200, and 300 of the above-described embodiments may have a configuration in which, for example, at least one of an antiglare layer, an antireflection layer, a polarizing filter layer, an antistatic layer, and a stainproof treatment layer is formed on the viewing side of the substrate 39 or 239. With this configuration, a function to reduce reflection of outside light, a function to prevent dust and stains from attaching, a function to prevent scratches, or the like may be added depending on the type of a layer formed on the viewing side of the substrate 39 or 239, enabling aged deterioration in viewing angle characteristics to be prevented.

The buffer layer-containing light dispersion member 500 of the above-described embodiment may have a configuration in which, for example, at least one of an antiglare layer, an antireflection layer, a polarizing filter layer, an antistatic layer, and a stainproof treatment layer is formed on the surface on the opposite side of the substrate 44 to the surface thereof facing the buffer layer 8. With this configuration, a function to reduce reflection of outside light, a function to prevent dust and stains from attaching, a function to prevent scratches, or the like may be added depending on the type of a layer formed on the display device side of the substrate 44, enabling aged deterioration in viewing angle characteristics to be prevented.

In addition, specific configurations with respect to the sizes and materials of respective portions of a light dispersion member, production conditions in a production process, or the like are not limited to the above-described embodiments, and can be changed appropriately.

### INDUSTRIAL APPLICABILITY

The present invention is applicable to displays of portable electronic devices, such as a mobile phone, televisions, personal computers, or the like.

### REFERENCE SIGNS LIST

1, 201, 301, 401 liquid crystal display device (display device)
6 liquid crystal display unit (display unit)
7, 207, 507 light dispersion member
8 buffer layer
8A buffer layer sheet
39, 239 substrate
39A substrate sheet
40, 240 light diffusion portion
40a, 240a light emitting end surface
40b, 240b light incident end surface
40c, 240c side face
41, 241 light shielding layer
42 air-cavity
243 space
44 substrate
100, 200, 300, 500 buffer layer-containing light dispersion member
100A intermediate article

1. A light dispersion member comprising:
a substrate that has optical transparency;
a light diffusion portion that is formed with a predetermined height on one surface of the substrate;
a light shielding layer that is formed with a thickness smaller than the height of the light diffusion portion in a region other than the light diffusion portion within the one surface of the substrate; and
a buffer layer that is formed on a surface on the opposite side of the light diffusion portion to a surface thereof facing the substrate, wherein
the light diffusion portion has a light emitting end surface that is in contact with the substrate and a light incident end surface that opposes the light emitting end surface and has a larger area than an area of the light emitting end surface, and
the buffer layer, by elastically deforming in a case that pressure is applied thereto from the substrate side, relaxes pressure applied to the light diffusion portion.

2. (canceled)

3. The light dispersion member according to claim 1, wherein
the buffer layer has a lower compressive elastic modulus than the light diffusion portion.

4. The light dispersion member according to claim 1, wherein
a thickness of the buffer layer is smaller than a height of a space formed between the light diffusion portions.

5. The light dispersion member according to claim 1, wherein
the buffer layer has adhesion and is adhered to the light incident end surface of the light diffusion portion.

6. The light dispersion member according to claim 1, comprising:
a substrate that has optical transparency on a surface on the opposite side of the buffer layer to a surface thereof facing the light diffusion portion, wherein
the substrate has a higher compressive elastic modulus than the buffer layer.

7. The light dispersion member according to claim 1, wherein
the buffer layer has a lower refractive index than the light diffusion portion.

8. The light dispersion member according to claim 1, wherein
the buffer layer has optical transparency to ultraviolet light.

9. The light dispersion member according to claim 1, wherein
the light dispersion member has a direction in which scattering intensity of light becomes relatively great and a direction in which scattering intensity of light becomes relatively small because of azimuthal anisotropy of the light diffusion portion.

10. The light dispersion member according to claim 9, wherein
the direction in which the scattering intensity of light becomes relatively great is parallel to a direction positioned between two diagonals in a case that a shape of the light dispersion member is a rectangle.

11. A display device comprising:
a display unit;
a light dispersion member that is disposed on a viewing side of the display unit; and
a buffer layer that is interposed between the display unit and the light dispersion member, wherein
the buffer layer, by elastically deforming in a case that pressure is applied thereto from the light dispersion member side, relaxes pressure applied to the light dispersion member.

12. The display device according to claim 11, wherein
the light dispersion member has a substrate that has optical transparency, a light diffusion portion that is formed with a predetermined height on one surface of the substrate, and a light shielding layer that is formed with a thickness smaller than the height of the light diffusion portion in a region other than the light diffusion portion within the one surface of the substrate,
the light diffusion portion includes a light emitting end surface that is in contact with the substrate and a light incident end surface that opposes the light emitting end surface and has a larger area than an area of the light emitting end surface, and
the buffer layer is disposed between the display unit and the light diffusion portion.

13. A method for producing a light dispersion member that includes
a substrate that has optical transparency,
a light diffusion portion that is formed with a predetermined height on one surface of the substrate,
a light shielding layer that is formed with a thickness smaller than the height of the light diffusion portion in a region other than the light diffusion portion within the one surface of the substrate, and
a buffer layer that is formed on a surface on the opposite side of the light diffusion portion to a surface thereof facing the substrate, the method comprising:
a step of forming the light shielding layer on a long substrate sheet that is formed into the substrate;
a step of forming the light diffusion portion on the substrate sheet on which the light shielding layer is formed;
a step of laminating a long buffer layer sheet that is formed into the buffer layer on the substrate sheet on which the light diffusion portion is formed; and
a step of winding the substrate sheet on which the buffer layer sheet is laminated.

14. (canceled)
